(19) United States
(12) Patent Application Publication
(10) Pub. No.: US 2025/0223710 A1
(43) Pub. Date: Jul. 10, 2025

(54) INTEGRATED SYSTEM(S) AND METHODS FOR CONTINUOUS ELECTROCHEMICAL CAPTURE AND REDUCTION OF CO2 FROM DILUTE SOURCES

(71) Applicant: The Board of Trustees of the University of Illinois, Urbana, IL (US)

(72) Inventors: Meenesh SINGH, Chicago, IL (US); Aditya PRAJAPATI, Chicago, IL (US); Rohan SARTAPE, Chicago, IL (US)

(21) Appl. No.: 18/853,432

(22) PCT Filed: Apr. 19, 2023
(86) PCT No.: PCT/US2023/065926

§ 371 Date: Oct. 2, 2024

Related U.S. Application Data
(60) Provisional application No. 63/332,644, filed on Apr. 19, 2022.

(51) Int. Cl. C25B 3/26; B01D 53/32; C25B 1/23; C25B 3/03; C25B 9/23; C25B 11/03; C25B 11/052; C25B 11/061; C25B 11/075

(52) U.S. Cl. CPC C25B 3/26; B01D 53/326; C25B 1/23; C25B 3/03; C25B 9/23; C25B 11/03; C25B 11/052; C25B 11/061; C25B 11/075; B01D 2255/806; B01D 2257/504; B01D 2258/0283

(57) ABSTRACT

In one aspect, the disclosure relates to a composition and a catalyst for substantially continuous CO₂ capture and reduction from dilute CO₂ sources including flue gas, wherein the flux of CO₂ captured is substantially equal to the flux of CO₂ reduction. The system can comprise integrated CO₂ capture and reduction components. An exemplary system includes a composition of a catalyst and electrolytes. The catalyst can comprise supported or unsupported mesh electrodes that comprise Cu, a Cu—Al alloy, and/or a copper oxide. In one aspect, the system includes one or more membranes separating an anodic side from a cathodic side in the system, where the one or more membranes can be a bipolar membrane, an anion exchange membrane, or both, which can reduce or eliminate Cl₂ production. In exemplary embodiments, the value-added products can be selected from CO, CH₄, C₂H₄, C₂H₅OH, CH₃COOH, CH₃OH, C₃H₆, and/or H₂.

### CROSS-REFERENCE TO RELATED APPLICATIONS

This application claims the benefit of U.S. Provisional Application No. 63/332,644, filed on Apr. 19, 2022, which is incorporated herein by reference in its entirety.

### FIELD OF THE DISCLOSURE

The present disclosure relates to systems and methods for the continuous electrochemical reduction using CO₂ from dilute sources such as flue gas and air. More specifically, the disclosure relates to a fully integrated system for continuous CO₂ capture and processing from dilute sources, and CO₂ reduction into value-added products and fuels.

### BACKGROUND

The increasing global energy demand has led to faster consumption of fossil fuels, which has increased anthropogenic CO₂ emissions, causing critical environmental issues. Even with the continuous progress in utilizing renewable energy sources like solar, wind, and hydroelectricity to reduce fossil fuel consumption, they still meet only a fraction of the current energy demands.

Recently, there has been a greater focus on developing additional CO₂ capture technologies, including liquid absorption, solid adsorption, membrane separation, and cryogenic distillation. At present, most of these technologies are restricted to lab-scale implementation due to their low capture flux, sorbent erosion and make-up, and high energy intensity of these processes. Liquid absorption by amine-based sorbents such as monoethanolamine (MEA) is one of the few technologies that has witnessed large-scale implementation by retrofitting to industrial plants emitting CO₂ directly into the atmosphere. However, due to strong MEA-CO₂ binding, high temperatures are required to release the CO₂ and recycle the MEA sorbent. This contributes to the additional energy penalty to make MEA absorption a continuous process. High-temperature recycling also contributes to solvent loss by evaporation, thereby impeding the widespread implementation of CO₂ capture using MEA sorption. Moreover, further utilization of CO₂ captured by MEA is challenging as the CO₂ is captured as carbamates. Carbamates have limited downstream applications, and unless this CO₂ is recovered in a gaseous phase, it may be challenging to utilize and convert CO₂ to value-added products. Hence, there is a need to develop an energy-efficient CO₂ capture technology exhibiting a high flux of CO₂ capture, and which can also be integrated with a CO₂ utilization technology to synthesize value-added products.

Hence, there is an urgent need to develop sustainable alternatives to mitigate the anthropogenic CO₂ concentration in the atmosphere. Electrochemical reduction of CO₂ into value-added chemicals and fuels helps with the urgently needed intermittent storage of renewable electricity and opens broader avenues for closed carbon cycle processes. Ethylene (C₂H₄) is an essential product of the CO₂ reduction reaction (CO2RR) primarily due to its high volumetric and gravimetric energy density. Moreover, C₂H₄ has a prominent global market size at $230 billion, the majority of which is attributed to its use in polymer industries for synthesizing the most prevalent plastics such as polystyrene, polyvinyl chloride, and polyethylene. The extensive use of C₂H₄ has led to its annual carbon footprint of 862 Mt CO₂ equivalents, which has the second-largest CO₂ emissions after ammonia. Therefore, renewably synthesizing C₂H₄ is of great interest to significantly reduce its impact on global warming.

Considerable efforts have been focused on designing various catalysts for CO₂ reduction. Reducing CO₂ to form 2 electron products like CO or formic acid has even achieved >90% Faradaic efficiencies (FE). Higher electron C1 products like CH₄ also have a reported FE of ˜90%. However, CO2RR to multi-carbon products is still challenging as C—C coupling has to compete with more favorable C—O and C—H bond formations on top of suppressing hydrogen evolution reaction (HER) on the catalyst surface. Furthermore, multi-carbon products like C₂H₄ are uniquely formed only on Cu-based electrocatalysts. Numerous strategies have been implemented to enhance the selectivity of Cu-based electrocatalysts to C₂H₄. Hori et al. showed that the selectivity towards CO2RR products is facet dependent and Cu (100) is more selective to form C₂H₄. More recently, Zhang et al. used electrodeposited Cu on a gas diffusion layer (GDL) in a conventional H-cell setup and demonstrated a high current density for C₂₊ products. De Luna et al. used a combination of electrodeposition and sol-gel methods to deposit Cu(0) and Cu(I) on a GDL and obtained a high C₂H₄ partial current density of 160 mA/cm² with a C₂H₄/CH₄ molar selectivity ratio of 200:1. The needle-like morphology Cu gas diffusion electrode (GDE) and the presence of Cu(I) species helped in tuning the selectivity towards C₂₊ products. Dinh et al. engineered the electrode-electrolyte interface using a highly concentrated 10 M KOH electrolyte and a Cu GDE. In such a concentrated electrolyte, the dissolved CO₂ present in the electrolyte is only in the first 120 nm of the catalyst layer, making an abrupt electrode-electrolyte interface leading to high selectivity towards C₂₊ products. The arrangement is unlike the one observed with a 1 M KOH electrolyte, where the reaction interface is more distributed and less selective to C₂₊ products. Pulsed-potential CO2RR is a relatively new strategy gaining attention to enhance the CO2RR selectivity towards C₂₊ products further. Cu-based catalysts suffer from deactivation over a period of time and are not stable for a long-term operation. Pulsing the applied potential has been shown to suppress HER, improve the catalyst stability, and maintain CO₂ saturation. Recent work by Tang et al. suggests that oscillations promote a dynamic surface restructuring of the catalyst that helps enhance the catalyst's selectivity and stability. However, more insights are needed to understand the effect of oscillating potential to help better control the selectivity of CO2RR products.

Furthermore, even though most of the recent works are capable of reaching industrially relevant CO2RR currents, all of them implement a gas diffusion electrode (GDE) configuration of an electrochemical cell that entrains the gaseous products with CO₂ in the product stream. Since the electrochemical processes have a low single-pass conversion (<10%), the product stream still contains >90% of CO₂. This makes it harder to implement such technologies on a larger scale as gas separation becomes economically challenging. O'Brien et al. showed ˜85% conversion for a single-pass conversion; however, they observed a drop in C₂H₄ selectivity and current density in achieving a high conversion. Additionally, implementing multi-pass CO₂ conversion by looping or recycling the exit CO₂ and product stream requires additional equipment, making this process economically unsustainable for long-term operation. Hence, there is a need to develop a catalyst-cell configuration that promotes high selectivity for C₂H₄ and has a product stream free of CO₂. Additionally, efficient integration of such a CO2RR system with a solar cell can provide opportunities to synthesize green plastics sustainably. Due to the high total cell voltage of Cu-based CO2RR systems, such integration schemes are scarcely seen in the literature and most of the solar-to-carbon (STC) efficiencies reported are around ˜5%. In accordance with the principles herein, a systematic investigation of the effect of oscillating potentials on CO2RR using a 3D Cu mesh and its integration with a triple-junction solar cell is achieved.

Stabilizing atmospheric CO₂ calls for a significant reduction in anthropogenic CO₂ emissions. There have been extensive efforts to individually develop CO₂ capture technologies and CO₂ utilization (or reduction) technologies to curb CO₂ emissions efficiently. However, current systems are not known that provide for rapid and economically viable reduction of atmospheric CO₂. These needs and other needs are satisfied by the present disclosure.

### SUMMARY

An exemplary system herein can comprise: a composition and a catalyst for substantially continuous CO₂ capture and reduction at near atmospheric pressure, and wherein the flux of CO₂ captured is substantially equal to the flux of CO₂ reduction. The system can comprise integrated CO₂ capture and reduction components. A method of maximizing efficiencies in various flue gas environments in accordance with the principles herein can comprise the steps of: manufacturing a continuous CO₂ capture and reduction system configured to produce high-purity, value-added products at a Faradaic efficiency ranging up to 60% and current densities up to 300 mA/cm² in liquid phase. Other reduction systems are contemplated in accordance with the principles herein, such as gas-phase CO₂ conversion.

An exemplary system constructed in accordance with the principles herein can comprise a composition of a catalyst and electrolytes for substantially continuous CO₂ capture and reduction at near atmospheric pressure from approximately 0.5-3 bar, and temperature range from approximately 20° C. to 40° C., and wherein the rate of CO₂ captured is substantially equal to the rate of CO₂ reduction.

The exemplary catalyst of the system in some embodiments comprises supported or unsupported mesh electrodes that comprise Cu, a Cu—Al alloy, at least one copper oxide, or any combination thereof, which are regenerated via cycling of applied potential. In some aspects, the supported electrodes have an aluminum support. In another aspect, the catalyst can include five or more mesh electrodes directly connected in a stack. Applied potentials can range from approximately 0.8V to −1.2V, for example. In an aspect, the electrodes have a mesh size of from about 40 mesh to about 120 mesh.

In one aspect, the system includes a membrane separating an anodic side from a cathodic side in the system, and the mesh electrodes can be present on the cathodic side in the system. In another aspect, the membrane can be a bipolar membrane, a cation exchange membrane, an anion exchange membrane, or a combination thereof. In any of these embodiments, the membrane can reduce or eliminate C₂ production relative to an otherwise identical membrane-less system.

Catalyst(s) of exemplary systems can comprise five or more meshes directly connected in a stack to provide higher Faradaic efficiency (from about 50% to about 60%, or about 57%) and current density of from about 550 mA/cm² to about 600 mA/cm² and a partial current density of ethylene of from about 250 mA/cm² to about 300 mA/cm². In some embodiments the catalyst(s) include active sites for CO₂ reduction comprising at least one of strained Cu layer with 111, 200, or 220 facets, or the like, on copper oxides, Cu alloyed with Al, and mixed oxides of Cu.

Exemplary electrolytes can comprise alkali metal chlorides, bicarbonates, and hydroxides mixed in an electrolyte composition, or other suitable electrolytes. The electrolyte composition can comprise, for example, CO₂ dissolved in a solution of alkali chloride and alkali bicarbonate (e.g. 0.75 M KCl, 0.025 M KHCO₃) in water. In one aspect, the alkali chloride can be KCl, NaCl, or any combination thereof. In another aspect, the alkali bicarbonate can be KHCO₃, NaHCO₃, or any combination thereof. In an aspect, the electrolyte can include from about 0.5 M to about 1 M of alkali chloride and from about 0.01 M to about 0.03 M of alkali bicarbonate, or about 0.75 M alkali chloride and about 0.025 M alkali bicarbonate. The system can be further defined by an integrated CO₂ capture and conversion device.

An exemplary method of maximizing efficiencies in various dilute CO₂ feed environments can comprise the steps of: manufacturing a continuous CO₂ capture and reduction system configured to capture CO₂ at a flux higher than 1 mmol/m2/s at less than 120 kJ/mol of energy using an electrodialysis unit, and produce high-purity (>30%), value-added products at a Faradaic efficiency ranging up to 60% and current densities up to 300 mA/cm² in a liquid-fed electrochemical reactor. In various embodiments, the fluidic connection between parts can be gas or liquid or both.

An exemplary method of maximizing efficiencies in various dilute CO₂ feed environments can comprise the steps of: manufacturing a continuous CO₂ capture and reduction system configured to capture CO₂ at a flux higher than 1 mmol/m²/s at less than 120 kJ/mol of energy using electrodialysis unit, and produce high-purity (>10%), value-added products at a Faradaic efficiency ranging up to 60% and current densities up to 1000 mA/cm² in a gas-fed electrochemical reactor.

In exemplary embodiments, the one or more value-added products can be selected from CO, CH₄, C₂H₄, C₂H₅OH, CH₃OOOH, CH₃OH, C₃H₆, H₂, or any combination thereof. In a further aspect, the disclosed system and method are selective for ethylene, such that the value-added products have a molar selectivity ratio of C₂H₄ to CH₄ is from about 200:1 to about 1000:1, or is from about 200:1 to about 500:1, or from about 500:1 to about 1000:1, or is at least about 200:1. In another aspect, a molar amount of C₂H₄ relative to all other gaseous products is from about 30% to about 60%, or from about 30% to about 45%, about 45% to about 60%, or from about 40% to about 50%.

Other systems, methods and components constructed in accordance with the principles herein are contemplated herein as well, and will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C show (FIG. 1A) a schematic of the migration-assisted moisture-gradient (MAMG) CO₂ capture technique using Toray paper as anode and Cu mesh as cathode with controlled CO₂ removal. (FIG. 1B) Schematic of CO2RR electrochemical cell using Cu mesh cathode with controlled CO₂ addition. (FIG. 1C) Schematic of the integrated system with MAMG CO₂ capture and electrochemical CO2RR.

FIGS. 2A-2B show (FIG. 2A) pH change on the aqueous side of the MAMG electrochemical cell, indicating CO₂ capture at a migration current of 25 mA. (FIG. 2B) Total carbon balance of the dissolved CO₂ from HCO₃⁻ migration from the organic side, aqueous HCO₃⁻ concentration, and gaseous CO₂ released on the aqueous side.

FIGS. 3A-3D show the effect of controlled CO₂ removal on the MAMG experiments with migration current of (FIG. 3A) 25 mA, (FIG. 3B) 50 mA, and (FIG. 3C) 75 mA. The left zone indicates only the MAMG process, and the right zone indicates the controlled CO₂ removal by feeding fresh KOH solution with MAMG CO₂ capture. (FIG. 3D) Process operating lines for the MAMG CO₂ capture process showing the CO₂ removal rate (or CO₂ capture rate) as a function of the steady-state pH at different migration currents.

FIGS. 4A-4C show the change in the product distribution of CO2RR with pH at the reduction current density of (FIG. 4A) 25 mA/cm², (FIG. 4B) 50 mA/cm², and (FIG. 4C) 75 mA/cm².

FIGS. 5A-5E show (FIG. 5A) Dynamics of CO₂ saturation and the rate of CO₂ addition at different CO₂ sparging flow rates. Steady-state pH of CO2RR with controlled CO₂ addition at CO2RR current density of (FIG. 5B) 25 mA/cm², (FIG. 5C) 50 mA/cm², and (FIG. 5D) 75 mA/cm². (FIG. 5E) Process operating lines for CO2RR with controlled CO₂ addition process indicating the net CO₂ removal rate as a function of the steady-state pH at different CO2RR current densities.

FIGS. 6A-6D show (FIG. 6A) the combined process operating lines for CO₂ capture and reduction. The intersection of the CO₂ capture and CO2RR lines determines the operating point of the fully integrated system. (FIG. 6B) Evolution of pH with time for a fully integrated system. (FIG. 6C) Effect of impurities on the MAMG CO₂ capture technique. (FIG. 6D) CO2RR FE of a fully-integrated CO₂ capture and reduction system with time.

FIG. 7 shows a detailed schematic of MAMG.

FIG. 8 shows a comparison of the theoretical gaseous CO₂ released from the MAMG process vs. the experimental CO₂ released as monitored through GC.

FIG. 9 shows a cross-plot of the CO₂ addition rate versus pH.

FIGS. 10A-10B show (FIG. 10A) product distribution of CO2RR under various static potentials. (FIG. 10B) Purity of gaseous products from static potential experiments.

FIGS. 11A-11I show (FIG. 11A) the effect of Vₜ on C₂H₄ FE. (FIG. 11B) Effect of switching time on C₂H₄ FE (FIG. 11C) SEM micrographs of the 3D Cu mesh pre-CO2RR. (FIG. 11D) SEM micrographs of the 3D Cu mesh post-CO2RR at optimized oscillations. (FIG. 11E) FTIR spectra of 3D Cu mesh pre- and post-CO2RR. (FIG. 11F) XPS of 3D Cu mesh pre-CO2RR (FIG. 11G) XPS of 3D Cu mesh post-CO2RR. (FIG. 11H) XRD pattern of 3D Cu mesh pre-CO2RR. (FIG. 11I) XRD pattern of 3D Cu mesh post-CO2RR.

FIGS. 12A-12D show (FIG. 12A) partial current densities of all the CO2RR products and (FIG. 12B) gaseous product purity for the optimized square wave applied potential V_{b}=−1.2 V vs. RHE, Vₜ=0.6 V vs. RHE. (FIG. 12C) Comparison of gaseous product purity and half-cell potential with the recent literature. (FIG. 12D) Comparison of the performance of the current investigation with the FE and partial current density of C₂H₄ in non-GDE type H-Cell and Flow cell systems in the recent literature.

FIGS. 13A-13D show (FIG. 13A) a schematic of a membrane-less solar-driven CO2RR electrochemical cell. (FIG. 13B) JV characteristic curve for the triple-junction light absorber and the stable current obtained for the electrochemical cell for a given total cell potential. (FIG. 13C) Solar-to-fuel (STF) and solar-to-carbon (STC) efficiencies obtained from the solar-driven CO2RR experiment. The percentage values outside the parentheses indicate the actual STF or STC efficiencies and the percentage values inside the parentheses indicate the percentage share of the products on the pie charts. (FIG. 13D) Comparison of the STC efficiencies with the recent state-of-the-art solar-driven CO2RR systems. The left bars with citations represent the STC from current literature, and the right bar with no citation represents the STC of this investigation.

FIG. 14 shows a schematic of a square wave potential.

FIGS. 15A-15C shows (FIG. 15A) a SEM image of the pre-CO2RR 3D mesh catalyst. The square is the area selected for elemental mapping using EDS. Elemental mapping of (FIG. 15B) Cu and (FIG. 15C) Al on the pre-CO2RR 3D mesh catalyst.

FIGS. 16A-16D show (FIG. 16A) a SEM image of the post-CO2RR 3D mesh catalyst. The square is the area selected for elemental mapping using EDS. Elemental mapping of (FIG. 16B) Cu, (FIG. 16C) Al, and (FIG. 16D) 0 on the post-CO2RR 3D mesh catalyst.

FIGS. 17A-17B show (FIG. 17A) a SEM image of pre-CO2RR 3D mesh catalyst. (FIG. 17B) SEM image of post-CO2RR 3D mesh catalyst with switching time >2 s.

FIG. 18 shows Faradaic efficiency of ethylene as a function of the proportion of 0.1 M KHCO₃ in the electrolyte.

FIG. 19A shows the current density and C₂H₄ FE over an extended time period. FIG. 19B shows snippet of total cell voltage in a square-wave oscillation experiment.

FIG. 20 shows gas chromatograph to highlight anode chemistry. Light arrows indicate the OER and Cl₂ production at the anode. The dark arrows indicate the valve switching fluctuations when the GC switches the flow of the product stream between mol sieve and HayeSep D columns.

FIG. 21 shows a comparison of reduction currents with and without bipolar membrane.

FIG. 22 shows a schematic of MAMG process implemented in an electrodialysis stack.

FIG. 23 shows a process and instrumentation diagram showing the integration of CO₂ capture and conversion units that capture CO₂ from the flue gas and produces ethylene continuously.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

To provide integrated systems and methods that are designed for rapid and economically viable reduction in atmospheric CO₂, it is necessary to develop a variety of embodiments where integrated technologies can capture and reduce CO₂ into value-added products and fuels in a closed carbon cycle.

In accordance with the principles of the present disclosure, systems and methods herein can evaluate a variety of individual electrochemical CO₂ capture and electrochemical CO₂ reduction processes, and can achieve a functional, fully integrated continuous process for CO₂ capture from dilute sources such as flue gas (0.16% SO₂, 12.39% CO₂, 6.96% O₂, 80.49% N₂) and simulated flue gas (10% CO₂, 90% N₂) and further reduction of CO₂ into value-added products and fuels. For CO₂ capture, a migration-assisted moisture-gradient (MAMG) was integrated into a CO₂ capture process, where gaseous CO₂ was captured as HCO₃⁻ in a CO₂-binding organic liquid, transported under an electric field across an anion exchange membrane to an aqueous solution, and converted to dissolved CO₂ in the presence of water-abundant environment by equilibration between HCO₃⁻, CO₂, and CO₃²⁻. For CO₂ reduction, an electrochemical cell configuration was developed for a CO₂-free extraction of CO₂ reduction gaseous products such as CO, CH₄, and C₂H₄, and liquid products such as ethanol, propanol, and formic acid on a Cu mesh catalyst. Successful integration of these continuous CO₂ capture and reduction processes to value-added products at a Faradaic efficiency of ˜57% was achieved.

CO₂ utilization technology should always complement CO₂ capture technology to promote a decarbonized economy. Various thermochemical, photochemical, biochemical, and electrochemical techniques have been developed in the recent past to convert CO₂ to value-added products and fuels. The electrochemical reduction of CO₂, among other CO₂ utilization technologies, is desirable because of its high reaction rate, high control over the product selectivity, relatively milder operating conditions, and excellent potential for large-scale industrial applications.

Moreover, due to the availability of cheap electrons (i.e., inexpensive and abundant electricity), the further development of electrochemical CO₂ reduction reaction (CO2RR) has become even more lucrative in the present times. CO2RR can be used to synthesize various fuels and value-added products such as syngas, HCOOH, CH₄, C²⁺ products (C₂H₄, C₂H₅OH, etc.) such that an industrial-scale implementation of this process is desirable. However, most of these electrochemical systems with a gaseous CO₂ feed have a low single-pass conversion (<10%), and the gaseous product outlet still contains >90% CO₂. This incurs an additional cost of separating CO₂ from the product stream, which discourages scaling up of the new technology. Hence, the development of an electrocatalyst-electrochemical cell configuration for an efficient CO2RR with CO₂-free product stream is of the utmost importance.

For successful integration of CO₂ capture and a CO₂ utilization (or reduction) process, the rate of CO₂ captured must be at least equal to the rate of CO₂ reduction. This condition is necessary for the development of a high-throughput, continuous integrated CO₂ capture and reduction system as depletion in the concentration due to a poor CO₂ capture process may severely affect the performance of the CO₂ reduction process and consequently decrease the efficiency of the complete integrated process.

A few attempts of integrating CO₂ capture with CO₂ reduction processes have been made, but most of the processes are either highly energy-intensive or work in a discontinuous cycle of capture and reduction of CO₂. In accordance with the principles herein, exemplary systems and methods that systematically address all the above-mentioned challenges with CO₂ capture, reduction, and integration of the two processes are set forth. Here a high-flux electrochemical CO₂ capture technique is set forth where CO₂ (from a simulated flue gas; 90% N₂, 10% CO₂) can be captured in a CO₂-binding organic liquid and can be transported across an anion exchange membrane (AEM) to an aqueous medium of neutral pH as dissolved CO₂, HCO₃⁻, and CO₃²⁻ in the presence of an electric field.

The migration of the captured CO₂ can occur by interconversion of CO₂, HCO₃⁻, and CO₃²⁻ in the presence of a gradient of water between the aqueous and the organic medium. The CO₂ capture technique is a migration-assisted moisture-gradient (MAMG) CO₂ capture. For an exemplary CO₂ capture system, controlled CO₂ removal from the aqueous medium can be emulated by injecting fresh 0.1 M KOH solution that increases the pH of the aqueous medium by removing the dissolved CO₂ to determine the flux of CO₂ capture. A CO2RR electrochemical cell can be developed for CO₂-free gaseous product extraction using a Cu-mesh electrocatalyst. For this CO2RR system, a controlled CO₂ addition can be emulated by sparging CO₂ into the electrolyte at different flow rates to determine the flux of CO₂ removal. Integrating a CO₂ capture and a CO₂ reduction process eliminates the need for auxiliary CO₂ storage facilities and the associated energy penalties. Therefore, these two capture and reduction processes can be integrated and used to demonstrate a fully functioning integrated CO₂ capture and reduction system.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a catalyst,” “a copper oxide,” or “an electrolyte,” include, but are not limited to, mixtures or combinations of two or more such catalysts, copper oxides, or electrolytes, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Process Overview of Migration-Assisted Moisture-Gradient (MAMG) CO₂ Capture

### Experimental Methods

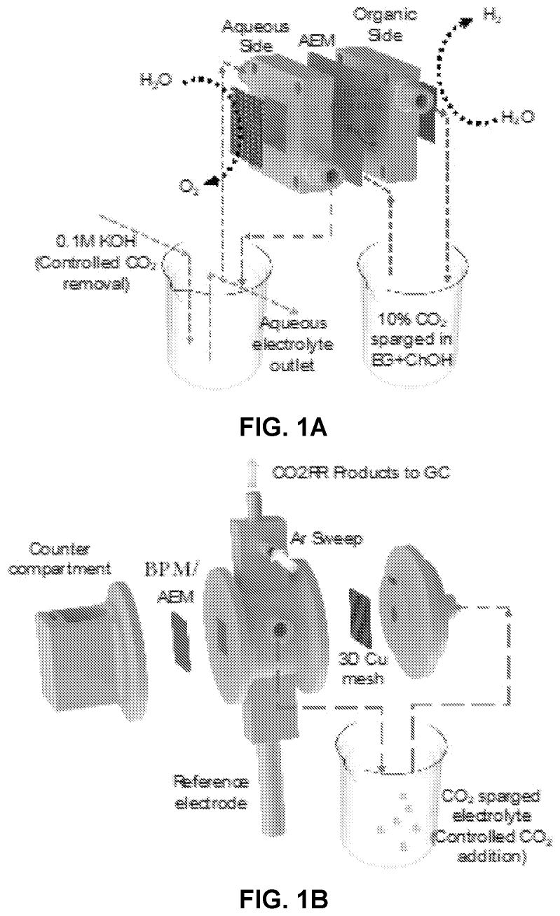

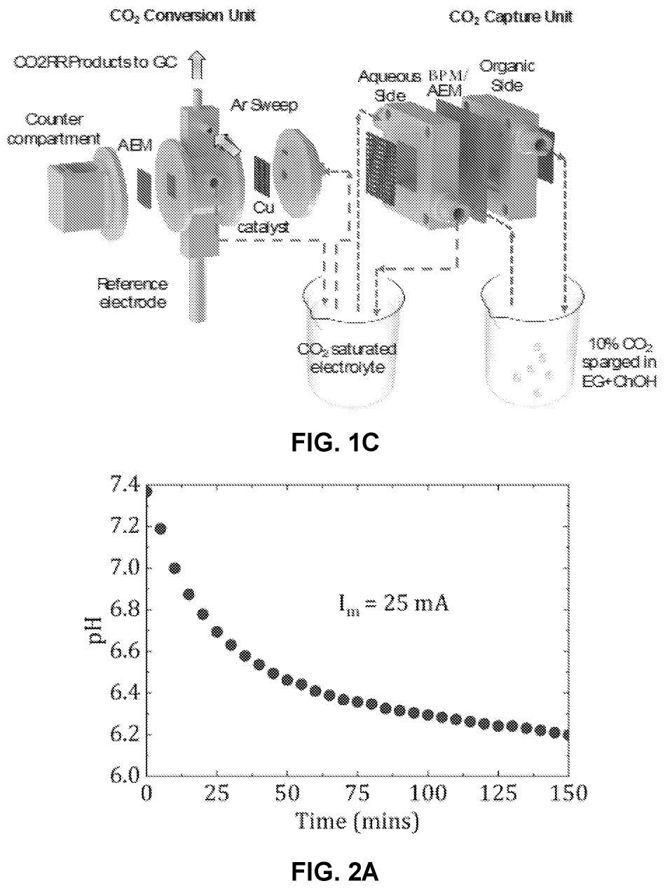

MAMG experiments were conducted on a custom 3D printed electrochemical cell, as seen in FIG. 1A. The electrochemical cell housed a 2×2 cm Cu-clad Al mesh (#120 mesh, FindProLabs, Zhejiang) as the cathode and carbon paper (190μ Toray 060, Fuel Cell Store) as the anode. The organic side consisted of a 1.25 M KOH saturated solution of ethylene glycol (EG) and choline hydroxide (ChOH) or choline chloride (ChCl) with EG:ChOH ratio of 1:0.05 (V/V) acting as the organic CO₂ binding organic liquid (CO2BOL). ChOH is a 45 wt % solution of ChOH in methanol. A simulated flue gas of 10% CO₂ and 90% N₂ was sparged in the CO2BOL reservoir. The aqueous side consisted of 25% 0.1 M KHCO₃ and 75% 1 M KCl (V/V %) electrolyte pre-equilibrated with CO₂ at a pH of 7.4. A SnowPure Excellion A200 AEM separated the aqueous and the organic sides. The solutions in aqueous and the organic sides were recirculated using a ColeParmer MasterFlex multi-drive peristaltic pump. The MAMG experiments were initiated by applying constant current using Eventek 32 V/10 A DC power supply. The concentration of dissolved CO₂ migrating from the organic side to the aqueous side was monitored as a function of the pH of the aqueous electrolyte using a Thermo Orion Star Versa Star Pro.

### Controlled CO₂ Removal

The controlled CO₂ removal experiments were conducted to determine the flux of CO₂ removal (and consequently, the rate of CO₂ capture). When the pH of the aqueous side reaches maximum CO₂ saturation at a steady-state, a fresh feed of 0.1 M KOH (pH=13) is injected at different flow rates between 20 and 160 μL/min into the aqueous reservoir to emulate CO₂ removal from the aqueous solution. The electrolyte in the aqueous reservoir is removed at the same flow rate at which fresh KOH is entering to prevent accumulation in the aqueous reservoir. The aqueous reservoir is constantly agitated using magnetic stirring to ensure the well-mixedness of the solution. The rise in the pH is monitored using the pH probe in the aqueous reservoir until the new steady state is reached at a higher pH. At this pH, the rate of CO₂ capture from the MAMG experiments must equal the rate of CO₂ removal by the controlled removal experiments.

### Electrochemical CO2RR

The CO2RR experiments were performed in an exemplary custom 3D printed electrochemical cell, as seen in FIG. 1B. A 1×1 cm Cu-clad Al mesh (99.9% Cu coating, FindProLabs, Zhejiang) was used as the working electrode along with an Ag/AgCl micro reference electrode (Innovative instruments inc.) and Pt (99.99% ACl alloys) as the counter electrode. An ion-exchanged separator, e.g. SnowPure Excellion A200 AEM, separated the working and the counter compartment of the electrochemical cell. The exemplary electrolyte used for the CO2RR experiments was the same as the aqueous electrolyte in the MAMG experiments to enable seamless integration between the two processes. The electrochemical experiments were conducted using a BioLogic SP300 potentiostat at various reduction currents in the range 10 to 700 mA/cm². Each experiment was run for 1 hour, and Ar was used as a sweeping gas in the headspace of the working compartment to entrain the CO2RR product gases to be quantified by SRI 8610C MG #5 gas chromatograph (GC) at 15 min intervals. At the end of each experiment, 1 ml of the electrolyte was sampled in a vial, and the liquid CO2RR products were quantified using Agilent 1260 Infinity II high-pressure liquid chromatography (HPLC).

### Controlled CO₂ Addition

The controlled CO₂ addition experiments were conducted to determine the flux of CO₂ addition (and consequently, CO₂ removal). The electrolyte is initially sparged with pure CO₂ at a high flow rate of 100 sccm to bring the dissolved concentration of CO₂ to saturation in the electrolyte ([CO₂]=33 mM, pH≈6.19). The CO₂ sparging flow rate was then lowered between 10 and 30 sccm. The CO2RR experiments are then conducted at various reduction currents. Since the CO2RR on Cu-based catalyst, the CO₂ concentration depletes faster at such low CO₂ sparging flow rates, which is monitored by observing the change in the pH of the electrolyte reservoir. At a steady state, the pH stabilizes, and the flux of CO2RR equals the flux of CO₂ addition.

### Integrated CO₂ Capture and Reduction

The integrated CO₂ capture and reduction experiments were performed to demonstrate the feasibility of seamless integration between the MAMG CO₂ capture technique and electrochemical CO2RR. The custom 3D printed setups from MAMG CO₂ capture and CO2RR were arranged such that both CO₂ capture and CO2RR units share the aqueous electrolyte, as seen in FIG. 1C. The MAMG unit was kept at a constant migration current of 75 mA, and the CO2RR unit was operated at a constant reduction current density of 25 mA/cm². The pH of the aqueous electrolyte was monitored using the pH probe, and once the steady-state was reached, the product distribution of CO2RR was measured using GC and HPLC.

### CO2RR and the Controlled CO₂ Addition Experiments

CO2RR experiments were performed in the electrochemical cell, as seen in FIG. 1B. The reduction was carried out under Galvanostatic currents for 1 hour, the gaseous products evolved were monitored using GC at 15 min intervals, and the liquid products were measured at the end of each experiment using HPLC. Initially, CO2RR efficiency at different CO₂ concentrations is evaluated. This is done because, theoretically, CO2RR is the most efficient with a CO₂ saturated electrolyte. However, when a CO2RR unit is integrated with a CO₂ capture unit, it must operate using the CO₂ concentration determined by the CO₂ capture unit. Since the CO2RR unit has to be a part of the integrated process, it is important to evaluate the CO2RR efficiency at different concentrations of dissolved CO₂.

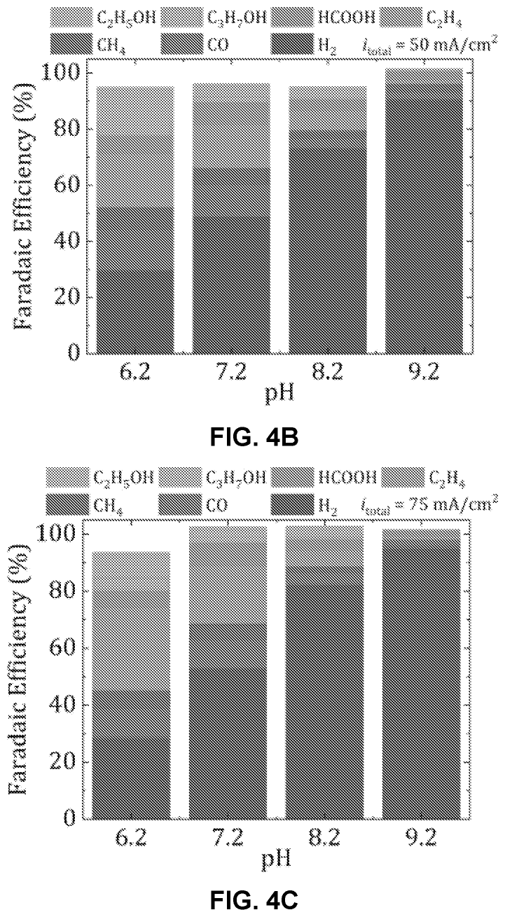

FIGS. 4A-4C shows the product distribution as a function of pH at different reduction current densities. As the solubility of CO₂ in aqueous media depends on its partial pressure in accordance with Henry's law, the pH was kept constant by sparging CO₂ into the aqueous electrolyte at different partial pressures at 100 sccm. FIGS. 4A-4C shows that CO2RR best performs at low pH of 6.2 where the electrolyte is saturated with CO₂. Since there has been extensive investigation done on similar CO2RR systems with electrolytes saturated with CO₂, these results are comparable to some of the outcomes reported in the literature. CO2RR shows 66.4% Faradaic efficiency (FE) towards C₂H₄, CO, and CH4 for all three current densities at pH 6.2 and 33.6% hydrogen evolution reaction (HER). As the pH increases, the CO2RR FE decreases as less CO₂ is available for CO2RR, and HER becomes more dominant. At pH 9.2 and above, the CO2RR FE becomes almost negligible (<5%), and the electrochemical cell almost exclusively shows >95% HER. The FE of CO2RR at varying reduction current densities and pH are measures of the rate of consumption of CO₂ from the aqueous electrolyte, which can be calculated as:

$${R}_{{CO}_{2} consumption} = {\sum }_{i} ( \frac{{I}_{i} \times A}{{n}_{i} F} )$$

where R_{CO2 consumption} (mmol/s) is the rate of CO₂ consumption from CO2RR, Iᵢ (mA/cm²) is the partial current density of the i^{th} CO2RR product, A=1 cm² is the area of the electrode, and nᵢ is the number of electrons transferred per mol of CO₂ consumed for the CO2RR product. Understanding the integration of this CO2RR system with a CO₂ capture unit was the next step in developing the fully integrated setup. This was done by employing a pseudo-integrated system of CO2RR with controlled addition of CO₂.

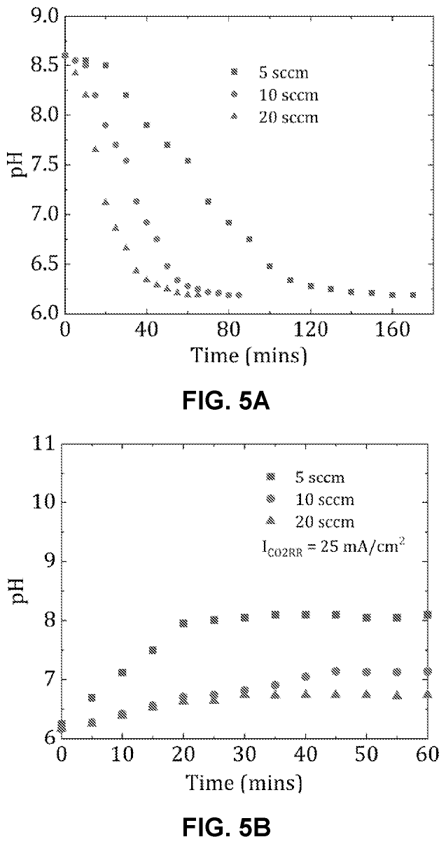

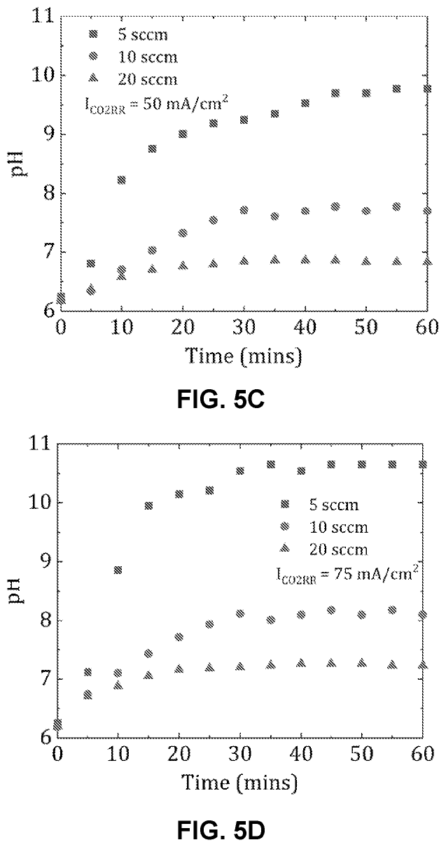

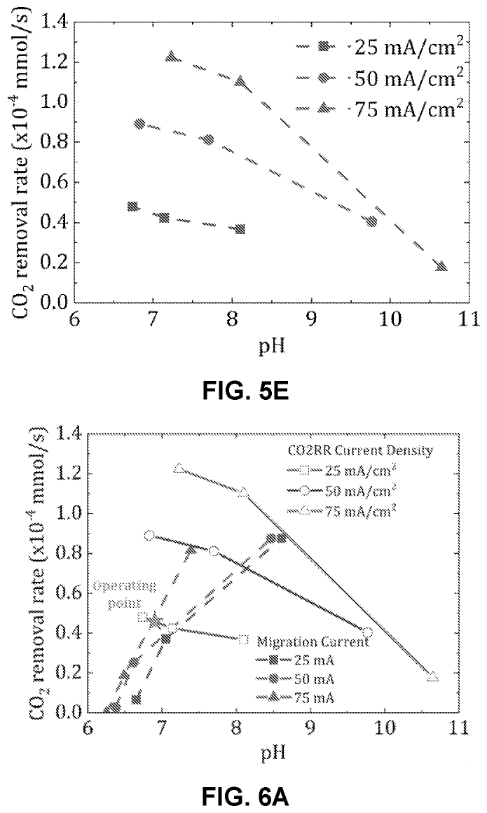

The controlled addition of CO₂ was performed by sparging pure CO₂ at different flow rates in the aqueous electrolyte. Sparging pure CO₂ ensures that, given sufficient time, the solution must reach CO₂ saturation in the absence of any CO₂ consumption. In such experiments, the solubility is not limited by the partial pressure of CO₂, but the rate of addition of CO₂ is dependent on the mass transfer at the gas-liquid interface. Therefore, at higher CO₂ sparging flow rates, the pH of the electrolyte drops faster due to enhanced mass transfer and increased availability of CO₂, leading to a quicker saturation, as seen in FIG. 5A. The pH drop is relatively steeper when the pH is higher and starts to plateau as the CO₂ concentration reaches saturation in the aqueous electrolyte. This indicates that the CO₂ addition rate is not constant and changes with time. The CO₂ addition rate (R_{CO2 addition}) can be determined as:

$${R}_{{CO}_{2} addition} = \frac{Δ [ {CO}_{2} ]}{Δ t} = \frac{{[ {CO}_{2} ]}_{{t}_{2}} - {[ {CO}_{2} ]}_{{t}_{1}}}{{t}_{2} - {t}_{1}}$$

where R_{CO2 addition} is the rate of CO₂ addition, [CO₂] is the concentration of dissolved CO₂ determined from the pH of the electrolyte, and t₂ and t₁ are the times at which the concentration of CO₂ was measured (t₂>t₁).

Starting with a CO₂ saturated electrolyte of pH 6.2, these pseudo-integrated experiments were performed by varying CO₂ sparging rates at different CO2RR current densities. FIGS. 5B-5D show the effect of flow rates on the steady-state pH at different CO2RR current densities. At a lower CO₂ sparging rate, the steady-state pH is higher because the initial CO₂ consumption rate is higher than the CO₂ addition rate. As CO₂ consumption is also dependent on pH, the rate of CO₂ consumption decreases as the pH increases and a plateau is reached at a steady state. At higher CO₂ sparging flow rates, the steady-state pH is closer to saturation. As the CO2RR current density increases, the CO₂ consumption flux also increases as the partial current density of all the CO2RR products formed increases. This leads to an increase in steady-state pH for a given CO₂ sparging flow rate as seen at higher CO2RR current density in FIGS. 5C-5D. The net CO₂ removed from this pseudo-integrated setup can be determined as:

$${R}_{{CO}_{2} renewal , CO 2 RR} = {R}_{{CO}_{2} consumption} - {R}_{{CO}_{2} addition}$$

The results of the CO2RR with controlled addition can be better understood in terms of operating lines similar to the ones created for the MAMG CO₂ capture process with controlled CO₂ removal. These operating lines are shown in FIG. 5E. At a low CO2RR current density of 25 mA/cm², the operating line spans a lower pH range as the CO₂ consumption rate is lower. The pH is closer to saturation at a high CO₂ sparging flow rate of 20 sccm and increases to a higher value at a CO₂ sparging flow rate of 5 sccm. A similar trend is seen in the operating lines of 50 and 75 mA/cm². These operating lines complement the operating lines generated for MAMG CO₂ capture with controlled CO₂ removal.

### Integrated CO₂ Capture and Reduction

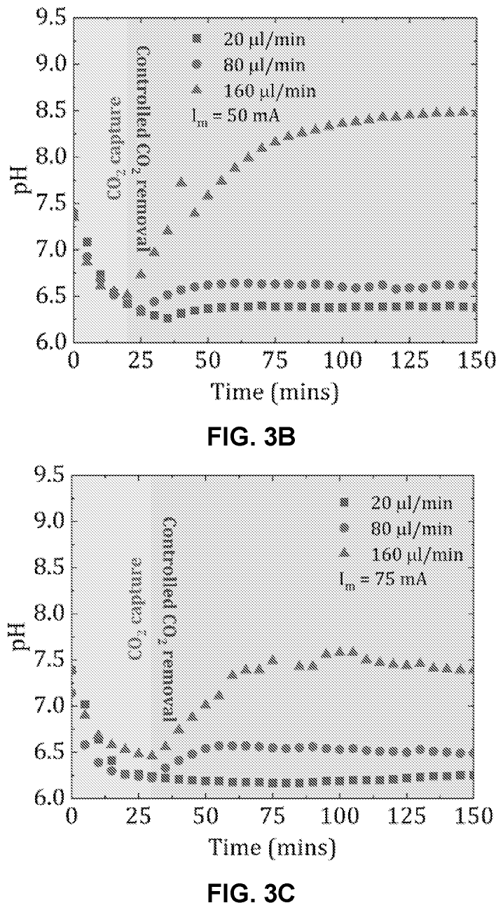

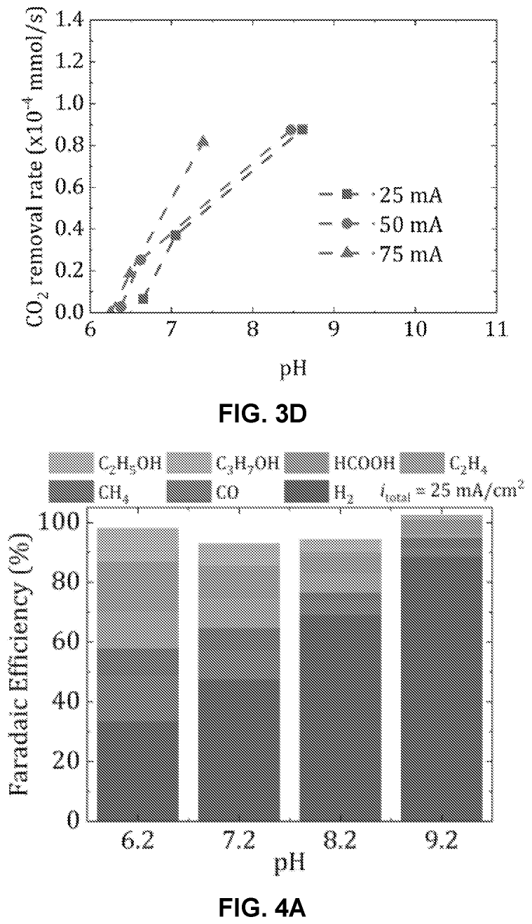

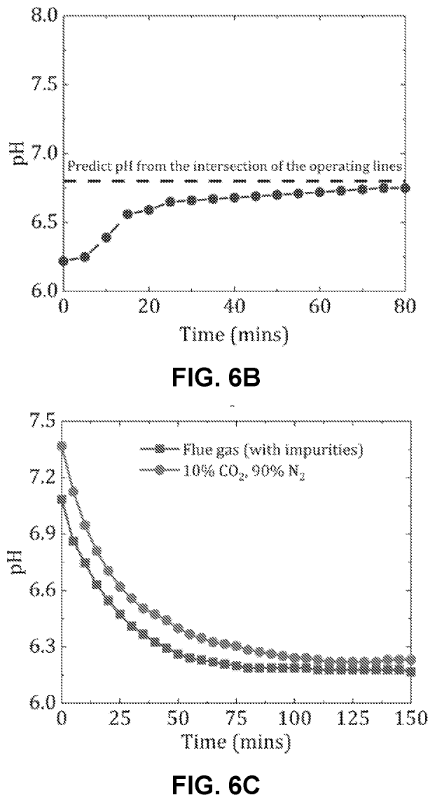

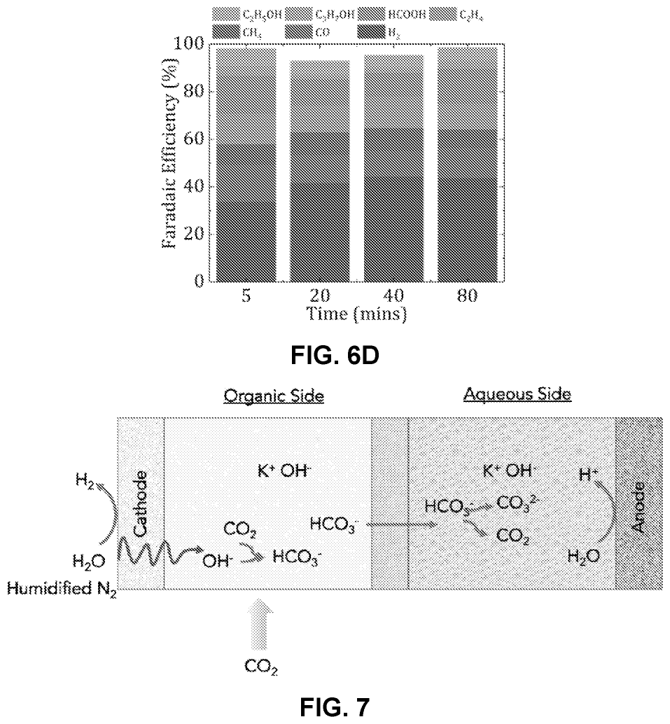

The MAMG CO₂ capture process system was integrated with the CO2RR unit, as seen in FIG. 1C, where both the capture and reduction systems share the aqueous electrolyte. The simulated flue gas sparged at the organic side of the capture unit was converted to HCO₃⁻ and transported to the aqueous side across the AEM/BPM as dissolved CO₂, HCO₃⁻, and CO₃²⁻. The CO2RR unit then utilized the dissolved CO₂ to convert CO₂ to value-added products and fuels such as CO, HCOOH, CH₄, C₂H₄, C₂H₅OH, and C₃H₇OH. It is necessary to match the flux of CO₂ capture from the capture unit with the flux of CO₂ consumption from the reduction unit to successfully implement a continuous integrated CO₂ capture and reduction process. The operating lines obtained from the individual CO₂ capture (FIG. 3D) and CO2RR processes (FIG. 5E) provide this information and are merged in FIG. 6A. The point of intersection of any of these curves indicate that at a given migration current for CO₂ capture and a current density of CO2RR, the rate of CO₂ capture equals the rate of CO₂ consumption. It also determines the pH of the aqueous electrolyte, which governs the product selectivity for CO2RR. CO2RR performs best at pH closer to 6.2. Hence, an integrated CO₂ capture and reduction process needs to be operated near a pH of 6.2. This can be achieved by operating the CO₂ capture process at a high migration current and the CO2RR process at a low reduction current density. It must be noted that the integrated CO₂ capture and reduction process must be operated in the range where the rate of CO₂ capture is greater than or equal to the rate of CO₂ consumption. If operated with CO₂ consumption rate higher than the CO₂ capture rate, the electrochemical CO2RR process will exhibit a dominant hydrogen evolution reaction (HER) as the concentration of the CO₂ in the common aqueous reservoir will always be low. If the integrated setup is operated with CO₂ capture rate greater than or equal to the CO₂ consumption rate, the electrochemical CO2RR process will utilize the maximum CO₂ available in the aqueous reservoir. Within the domain of the experiments, the point of intersection of MAMG CO₂ capture operating at a migration current of 75 mA and the CO2RR with 25 mA/cm² reduction current density occurs at a pH of ˜6.75. A fully integrated CO₂ capture and reduction system was operated at these conditions, and the change in pH was observed over time. It can be seen from FIG. 6B that the pH increases from 6.2 and stabilizes closer to pH 6.71 after the system reaches a steady-state. The steady-state pH of the fully integrated experiment is close to the pH predicted by the operating line. This similarity further delineates the importance and the authenticity of the process operating lines for the CO₂ capture and reduction processes.

A more realistic implementation of this integrated CO₂ capture and reduction process can be seen by understanding the influence of impurities typically present in a flue gas exhaust from a coal-fired power plant such as O₂ and SOₓ. It is imperative to observe the performance of the MAMG CO₂ capture process using realistic flue gas as the CO₂ capture unit is responsible for maintaining a steady concentration of CO₂ for the CO2RR unit. The influence of impurities of the MAMG CO₂ capture can be seen in FIG. 6C. The realistic flue gas comprises an approximate composition of 70% N₂, 19% O₂, 10% CO₂, <1% SOₓ. It can be seen that the performance of MAMG in the presence of impurities is almost identical to the performance with the impurities. The MAMG CO₂ capture process is a robust technique in the presence of contaminants due to the high affinity of the organic phase towards selective capture of CO₂ and its conversion to HCO₃⁻. The CO2RR product distribution as a function of time for this fully integrated experiment can be seen in FIG. 6D. Initially, the pH is near saturation, as seen in FIG. 6B, and hence, it has the highest concentration of CO₂. The CO2RR efficiency is at its highest of ˜64% FE of CO2RR. According to the steady-state predicted from the operating lines, the pH must stabilize around 6.75. As the system moves towards a steady-state, the pH increases. At 20 mins, the pH of the solution is close to 6.5, and the CO2RR FE reduces to ˜57%. As the time passes further, the pH plateaus around 6.71; hence, there are not significant changes observed in the FE at 40 and 80 mins. The CO2RR efficiency at a steady state is 57.75%.

In accordance with the principles herein, a systematic protocol for understating and establishing a fully integrated CO₂ capture and reduction system is set forth. A migration-assisted moisture-gradient (MAMG) CO₂ capture process was benchmarked wherein CO₂ from simulated flue gas is chemisorbed as HCO₃⁻ in a CO₂ binding organic liquid of KOH saturated ethylene glycol and choline hydroxide. This HCO₃⁻ is transported across an anion exchange membrane to an aqueous side where it gets converted to dissolved CO₂ in the presence of a water-abundant environment by equilibrium interconversion between HCO₃⁻, CO₂, and CO₃²⁻. The concentration of dissolved CO₂ was determined by monitoring the pH of the aqueous electrolyte. A pseudo-integrated process with controlled CO₂ removal was incorporated by injecting a fresh feed of KOH at various flow rates to generate the process operating lines for the MAMG CO₂ capture. These operating lines indicated the CO₂ removal rate at various migration currents. Secondly, the electrochemical CO2RR process was benchmarked by evaluating CO2RR efficiency for different electrolyte pH. A pseudo-integrated process with controlled CO₂ addition was incorporated by sparging pure CO₂ in the electrolyte at varying flow rates to generate the operating lines for CO2RR. These operating lines indicated the net CO₂ removal rate from the CO2RR process at various CO₂ reduction current densities. Finally, for successful and continuous integration of MAMG CO₂ capture and electrochemical CO2RR processes, the operating point must be at or near the intersection of the operating lines from both processes. This hypothesis was tested by running a fully integrated experiment at 75 mA migration current for the MAMG CO₂ capture unit and 25 mA/cm² reduction current density for the CO2RR unit. The pH at the point of intersection from the operating line was ˜6.75, while the actual steady-state pH from the experiment was 6.71. The actual pH is close to the pH predicted by the intersection of the operating lines, supporting the initial hypothesis. Furthermore, the integrated experiments were performed using a more realistic flue gas with impurities such as O₂ and SOₓ. The MAMG CO₂ capture process showed an identical performance with and without the impurities due to the high CO₂ affinity of the organic phase. A fully integrated CO₂ capture and reduction showed a steady-state CO2RR FE of ˜57%. Such a systematic and individual evaluation of the CO₂ capture and CO₂ reduction process integration and scale-up.

### Example 2: Experimental Methods

The following exemplary details of materials and chemicals used to generate results herein, 3D printing and fabrication of the electrochemical cells used for both exemplary CO₂ capture and reduction processes, and the exemplary GC and HPLC methods for quantifying the CO₂ reduction products.

### Materials

Table 1 shows the list of all the exemplary consumable items, their purity, and the source used in the CO₂ capture and reduction experiments.

TABLE 1
Chemicals and Materials Used in Experiments

| Material | Source |
|---|---|
| 3D printing clear resin (RS-F2-GPCL-04) | FormLabs |
| KCI (99.999%) | Sigma Aldrich |
| KOH (>85%) | Sigma Aldrich |
| KHCO₃ (99.99%) | Sigma Aldrich |
| DI water (HPLC Grade) | Sigma Aldrich |
| Choline hydroxide (45 wt % in CH₃OH) | Sigma Aldrich |
| Ethylene glycol (99.9%) | Renowned Trading, LLC |
| Carbon paper (Toray 060) | Fuel Cell store |
| Cu mesh | FindProLabs, Zhejiang |
| CO₂ (99.99%) | Praxair |
| N₂ 99.99% | Praxair |

### Fabrication of Devices

The 3D models of the different parts of the exemplary MAMG CO₂ capture setup and exemplary CO2RR setup were designed in SolidWorks® (2018, Dassault Systems) and then 3D printed using a stereolithography (SLA) 3D printer (Form 2, Formlabs Inc., USA). A clear FLGPCL02 resin activated by a 405 nm laser was used to 3D print optically clear microfluidic devices with 150 μm of lateral and 25 μm of axial resolutions. The clear resin was chemically resistant to various solvents in a wide range of pH 0-14. The printed parts were washed with isopropyl alcohol (IPA) (90%, Sigma-Aldrich) bath for 20 mins in the Form Wash (Formlabs Inc., USA) to remove the residues of the resin from the external surface. The post-washed 3D printed device was finished by removing supports and curing for 20 minutes in the Form Cure. (Formlabs Inc., USA). The optical transparency of the 3D printed ED device was improved by wet sanding using 400 to 12000 grit pads, followed by spray painting of resin.

### Product Distribution Analysis for CO2RR

The CO2RR products were quantified using chromatographic techniques. The gaseous products evolved from CO2RR such as H₂, CO, CH₄, and C₂H₄ are quantified using gas chromatography (GC). The liquid products such as HCOOH, C₂H₅OH, and C₃H₇OH were quantified using high-pressure liquid chromatography (HPLC).

GC: Gaseous products were quantified using an SRI 8610C GC MG #5. At the interval of 15 minutes, the gaseous products evolved were detected by passing the outlet from the electrochemical cell to the GC with argon as the carrier gas, and the product detection was done through thermal conductivity detector (TCD) and flame ionization detector (FID). The product gases in the GC were passed through two size-exclusion columns, Mol-sieve 8A and HaySep D. HaySep D efficiently separates larger molecules like C₂H₄. Smaller molecules like H₂ (from HER), CO, and CH₄ were separated through Mol-sieve 8A. The hydrocarbons were detected using FID, and non-hydrocarbon products were detected using TCD.

HPLC: The quantification of liquid products of CO₂ reduction was performed using High-pressure liquid chromatography (HPLC) on Agilent Infinity 1260 II HPLC with a 300 mm×7.5 mm Agilent Hi-plex-H column and a refractive index detector (RID). An isocratic elution of 1 mM H₂SO₄ mobile phase was established at 0.6 mL/min. The column temperature was set to 60° C., and the RID temperature was set to 35° C. For each sample analysis with a total run time of 30 mins, a 10 μL sample was injected into the system through an autosampler. This operating method was developed by observing the retention times of the electrolyte and the possible CO₂ reduction products: HCOOH, HCHO, CH₃OH, CH₃COCH₃, CH₃COOH, C₂H₅OH, and C₂H₂O₄ so that none of the peaks overlap with each other in the shortest run time.

### Working Principle of the Migration-Assisted Moisture-Gradient CO₂ Capture Process

FIG. 7 shows a detailed schematic of the entire process. CO₂ is sparged into the organic side, where it is chemisorbed by the 1.2 M KOH solution in CO₂BOL to form HCO₃⁻. An anion exchange membrane (AEM) separates the organic side from the aqueous, initially comprising 0.1 M KOH. The separation of the organic and aqueous sides creates a moisture gradient across the AEM, which initially drives the HCO₃⁻ diffusion across the AEM. In other embodiments, a Bipolar Membrane (BPM) can be used in the place of the AEM. The Bipolar membrane can be configured to maintain or conserve chloride ions on both sides of the membrane.

On the aqueous side, the diffused HCO₃⁻ converts back to CO₂ and CO₃²⁻ thereby reducing the pH of the alkaline aqueous medium. This moisture-gradient facilitated transfer of HCO₃⁻ is accelerated by establishing an electric field across the device. The carbon paper cathode on the organic side is supplied with humidified N₂ and acts as a gas diffusion electrode to reduce water to H₂ and serves as a constant source to generate OH⁻ thereby increasing the CO₂ uptake. The aqueous side is anodic and attracts the HCO₃⁻ ions, further enhancing the rate of transfer of HCO₃⁻ and CO₂ release on the aqueous side.

### Assessment of Mass-Transfer Limitations in the MAMG CO₂ Capture Process

The MAMG process has four sequential processes—i) Absorption of CO₂: mass transfer of CO₂ from gas bubbles into the organic solution, ii) Formation of HCO₃⁻ reaction of absorbed CO₂ with OH⁻ to produce HCO₃⁻, and iii) Migration of HCO₃⁻: migration of HCO₃⁻ from organic to the aqueous solution, and iv) Hydrolysis of HCO₃⁻: reaction of HCO₃⁻ and H₂O to release CO₂. The acid-base reactions, such as the Formation and Hydrolysis of HCO₃⁻ (process ii and iv) are usually very fast. Here the limiting process could be either Absorption of CO₂ or the Migration of HCO₃⁻. To identify the limiting process, we have compared the rates of CO₂ absorption in the organic solution (i.e., process i) with the rate of CO₂ migration (i.e., process iii). The rates of CO₂ absorption in MAMG process were obtained from previously published data. The data for CO₂ removal rates (or migration rates) are already provided in FIG. 6A. From the FIG. 9, it is observed that the CO₂ absorption rates are much higher than the rates of CO₂ removal from the organic solution. In other words, the rate at which CO₂ migrates in the form of bicarbonate ions remains lower than the CO₂ absorption rate. This indicates that MAMG CO₂ capture process is not mass transfer limited due to CO₂ absorption.

Calculation of Dissolved CO₂, Gaseous CO₂, and Total Carbon Balance

Dissolved CO₂: MAMG CO₂ capture performance was measured by observing the drop in the pH on the aqueous side due to the migration of HCO₃⁻ and its conversion to CO₂ and CO₃²⁻. Using the well-established aqueous equilibrium relationship of these species, the CO₂ concentration was calculated using pH as follows:

The equilibrium constants are obtained from these aqueous reactions:

CO+OH⁻ [symbol] HCO₃⁻(K_{1,aq}=10^{7.63} L/mol)

CO₂+H₂O+CO₃²⁻ [symbol] 2HCO₃⁻(K_{2,aq}=10^{3.88})

Using the above relationship, the HCO₃⁻ and CO₃²⁻ concentrations can be expressed in terms of CO₂ as

$$[ {HCO}_{3}^{-} ] = {K}_{1 , aq} \times [ {CO}_{2} ] [ {OH}^{-} ]$$

$$[ {CO}_{3}^{2 -} ] = \frac{{[ {HCO}_{3}^{-} ]}^{2}}{{K}_{2 , aq} \times [ {CO}_{2} ]} = \frac{{( {K}_{1 , aq} \times [ {CO}_{2} ] [ {OH}^{-} ] )}^{2}}{{K}_{2 , aq} \times [ {CO}_{2} ]} = {K}_{1 , aq}^{2} \times \frac{{[ {CO}_{2} ] [ {OH}^{-} ]}^{2}}{{K}_{2 , aq}}$$

Imposing electroneutrality on the aqueous side, the total ionic balance can be written as:

$${\sum }_{i} {z}_{i} {C}_{i} = 0$$

where zᵢ is the charge of the ionic species and Cᵢ is the concentration of the species. The electroneutrality equation can be expressed in terms of the ionic species on the aqueous side as:

$$[ {K}^{+} ] + [ {H}^{+} ] - [ {OH}^{-} ] - [ {Cl}^{-} ] - [ {HCO}_{3}^{-} ] - 2 [ {CO}_{3}^{2 -} ] = 0$$

$$[ {K}^{+} ] + [ {H}^{+} ] - [ {OH}^{-} ] - [ {Cl}^{-} ] - {K}_{1 , aq} \times [ {CO}_{2} ] [ {OH}^{-} ] - 2 {K}_{1 , aq}^{2} \times \frac{{[ {CO}_{2} ] [ {OH}^{-} ]}^{2}}{{K}_{2 , aq}} = 0$$

The only unknown in is [CO₂] as [K⁺]=0.775 M and [Cl⁻]=0.75 M being the spectator ions that do not participate in the equilibrium reactions, [H₊]=10^{-pH} M, and [OH⁻]=10^{pH-14} M.

### Gaseous CO₂

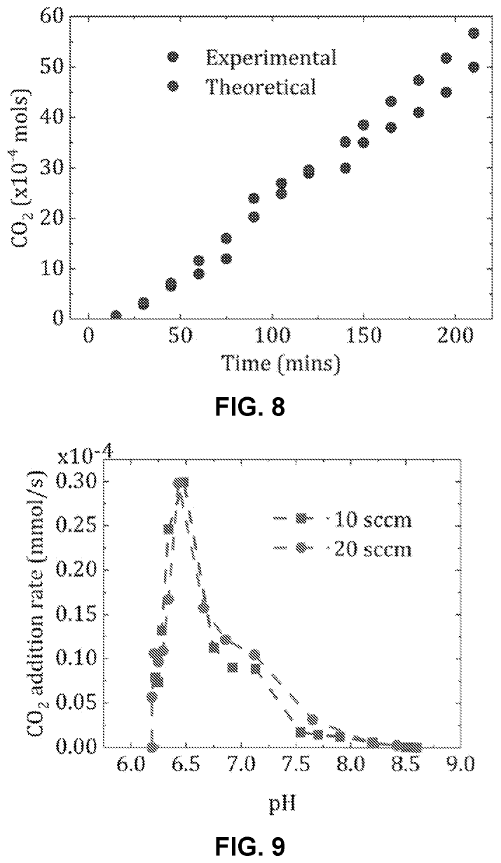

The concentration of the gaseous CO₂ was determined by Ar sweeping the headspace of the aqueous reservoir of the MAMG CO₂ capture system into GC. As the aqueous solution reaches saturation pH, the HCO₃⁻ migrating from the organic side to the aqueous side can no longer be held as dissolved CO₂ and, therefore, bubbles out as gaseous CO₂. When the primary charge carrier anion in the organic side is HCO₃⁻, the total HCO₃⁻ transferred can be given as:

$$[ C ] = \frac{{I}_{m} \times t}{F}$$

where [C] is the total carbon transferred from the organic side to the aqueous side, Iₘ (mA) is the migration current, t is the duration of the MAMG CO₂ capture experiment, and F=96485 C/mol is Faraday's constant. Theoretically, the gaseous CO₂ evolved can be obtained by:

$$[ {CO}_{2 ( g )} ] = [ C ] - ( [ {CO}_{2 ( aq )} ] + [ {HCO}_{3}^{-} ] + [ {CO}_{3}^{2 -} ] )$$

where [C] is obtained from equation as described above, [CO_{2(aq)}], [HCO₃⁻], and [CO₃²⁻] are obtained from pH as described above. FIG. 8 shows a comparison of the theoretical and the experimental gaseous CO₂ evolved during the MAMG CO₂ capture process. It is clear that the experimental value follows closely with the theoretical value and thus, accounts for all the carbon migrating from the organic side to the aqueous side. This further supports the assumption that the pH drop in the aqueous solution is only due to the HCO₃⁻ migrating and getting converted to dissolved CO₂.

### pH of the Electrolyte at Various Partial Pressures of CO₂

The equilibrium pH of the electrolyte depends on the partial pressure of CO₂ by Henry's law. Therefore, the effect of pH on CO2RR experiments was studied by varying the partial pressures of CO₂ for 100 sccm of total gas sparging into the electrolyte solution. The equilibrium concentration of CO₂ is related to its partial pressure as:

$$[ {CO}_{2} ] = H \times {P}_{CO 2}$$

where H=33 mM/atm is the Henry's constant, and P_{CO2} is the partial pressure of CO₂. The total flow rate of the sparged gas was maintained at 100 sccm, and the fraction of CO₂ was balanced with Ar at different pH. Table 2 shows how varying the partial pressure of CO₂ affected the pH.

TABLE 2
Data Showing the Flow Rate of CO₂ Used to Maintain Constant
pH to Investigate CO2RR at Different pH Values

| pH | P_{CO2} | CO₂ Flow Rate (sccm) | Ar Flow Rate (sccm) |
|---|---|---|---|
| 6.2 | 1 | 100 | 0 |
| 7.2 | 0.1 | 10 | 90 |
| 8.2 | 0.01 | 1 | 99 |
| 9.2 | 0.001 | 0.1 | 99.9 |

### Rate of CO2 Addition as a Function of pH

While working with a pseudo-integrated process of CO2RR and the controlled addition of CO₂, it was identified that sparging pure CO₂ at various flow rates into the electrolyte affects the rate at which the CO₂ is dissolved in the solution. The pH saturation at higher flow rates like 20 sccm is faster compared to slower flow rates like 5 sccm. The rate of CO₂ addition is also dependent on the pH of the electrolyte as it nears saturation. Initially, when the CO₂ concentration is negligible in the electrolyte, the rate of CO₂ addition is constant and is virtually independent of the pH. However, the slope of the rate changes as the saturation pH approaches. This behavior is important to visualize as it indicates the rate at which CO₂ is added to the solution near saturation pH for varying flow rates. Subsequently, this information is also helpful in calculating the net CO₂ removal rate from the pseudo-integrated CO2RR with a controlled CO₂ addition process. FIG. 9 shows this cross-plot visualization between the CO₂ addition rate and pH from the data obtained for pH vs. time and CO₂ addition rate vs. time in the controlled CO₂ addition experiments.

### Example 3: CO₂-Free, High-Purity Ethylene from Electroreduction of CO₂ on a 3D Cu Mesh with 4% Solar-to-Ethylene Efficiency

C₂H₄ is a hydrocarbon of extensive societal, environmental, and industrial importance. Therefore, synthesizing C₂H₄ sustainably via electrochemical CO₂ reduction reaction (CO2RR) is an attractive area to explore. Even though many existing CO2RR systems have reached industrially relevant current densities, almost all use a gas diffusion electrode (GDE)-based electrochemical system with a single-pass conversion of <10%. This leads to a lower concentration of C₂H₄ in the gaseous product stream that mainly comprises CO₂, which contributes significantly to the cost of post-CO2RR separation of products, rendering even processes with high CO2RR current densities unfit for scaling up. Here an aqueous flow-through electrochemical cell was developed to enhance the activity and selectivity of C₂H₄ on a 3D Cu mesh electrode by applying square wave oscillating potentials. The oxidation phase of the square-wave oscillating potential for in-situ generation of active Cu(OH)₂ flakes on the mesh can be controlled, which helps enhance the selectivity of CO2RR towards C₂H₄ during the reduction phase. A high C₂H₄ Faradaic efficiency (FE) of ˜58%, unprecedented C₂H₄ current density of 306 mA/cm² in the aqueous cell, and gaseous C₂H₄ purity of ˜28 mol % without CO₂ in the product stream are obtained. Integrating the 3D Cu mesh catalyst in a PV-electrolyzer yields a remarkable solar-to-carbon (STC) efficiency of ˜10% with a solar-to-C₂H₄ efficiency of ˜4%, almost double the current state-of-the-art solar-driven CO2RR systems. The novel electrochemical cell and catalysts offer several breakthroughs necessary for the sustainable manufacturing of C₂H₄.

### Methods and Materials

Electrochemical measurements: An Al mesh (#120) coated with 99.9% Cu of 1×1×0.12 cm (FindProLabs, Zhejiang) was electrochemically polished in a well-stirred electrochemical cell with 85% H₃PO₄ as the electrolyte and carbon paper as the counter electrode. The catalyst was rinsed with DI water post polishing and then argon-dried to be used as is in all the CO2RR experiments. The electrolyte used was a mixture of 0.1M KHCO₃ and 1M KCl (25:75 V/V %). The electrochemical measurements were conducted using a Biologic SP 300 potentiostat in a custom 3D printed electrochemical cell, as seen in FIG. 1B. CO₂ was sparged into the external electrolyte reservoir, where the electrolyte was recycled via a peristaltic pump. An Ag|AgCl, 3.4M KCl leak-free micro-electrode (LF-1-50, Innovative Instruments Inc.) was used as the reference electrode, and a mechanically polished Pt (99.99%, ACl Alloys) or Ni-Foam was used as the counter electrode. The working and the counter compartments are separated by a SnowPure Excellion 1200 anion exchange membrane (AEM). The gaseous products in the headspace of the working compartment were swept using Ar to a gas chromatograph (GC, SRI 8610C) to quantify the gaseous products at the interval of 15 mins. Both static and oscillating potential CO2RR experiments were conducted for a duration of 1 hour. At the end of each CO2RR experiment, 0.5 ml of the electrolyte was extracted for the liquid product quantification using high-pressure liquid chromatography (HPLC, Agilent 1260 II Infinity).

### Characterization

The 3D Cu mesh was characterized before and after CO2RR by scanning electron microscopy (SEM), energy-dispersive X-ray spectroscopy (EDS), X-ray photoelectron spectroscopy (XPS), X-ray diffraction (XRD), and Fourier transform infrared spectroscopy (FTIR). SEM and EDS were performed using Hitachi SU8030 Field-Emission SEM, XPS was performed using Thermo Scientific ESCALAB 250XI microprobe with an Al Kα source, FTIR was performed on Bruker Invenio S in the attenuated total reflectance (ATR) mode using a Pike VeeMax II variable angle accessory and a 60o Ge ATR crystal, and XRD was performed on Bruker D8 Advance using Cu Kα radiation source.

### Solar-Driven CO2RR

A custom 3-D printed membrane-less electrochemical cell was used for the solar-driven CO2RR experiments. A membrane-less electrochemical cell setup was adopted for the solar-driven CO2RR experiments to reduce the total cell voltage for the light absorber to sustain a constant applied potential. Two triple-junction (GaInP/GaAs/Ge, Spectrolab Inc.) were connected in series with the negative terminal connected to the 3D Cu mesh and the positive terminal connected to the Ni-foam. The solar cells were irradiated using Oriel LCS-100 solar simulator to simulate AM 1.5 with a total illumination area of 16 cm². The oscillations in potential were implemented in the solar-driven CO2RR experiments using an Arduino Uno board with a relay circuit attachment.

### Results and Discussion

Static potential: Static potential experiments were conducted in the range of −0.8 to −1.4 V vs. reversible hydrogen electrode (RHE) to benchmark the catalyst activity towards CO2RR against the previously reported Cu-based catalysts in an H-cell-type configuration. The applied potential was measured as:

$$E ( V vs RHE ) = E ( V vs Ag \vert AgCl ) + 0.059 \times pH + {E}_{ref}$$

where E(V vs Ag|AgCl) is the potential applied against the reference electrode using the potentiostat and E_{ref==0.205V} is the standard reduction potential of the reference electrode with 3.4 M KCl electrolyte.

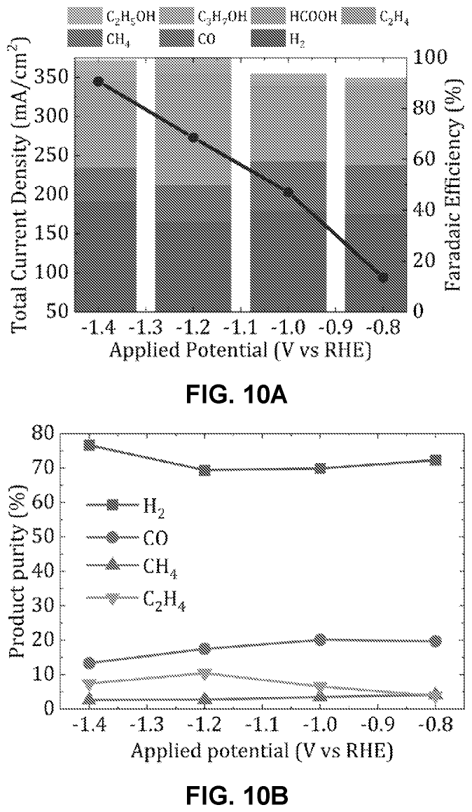

FIG. 10A shows the product distribution of CO2RR at various applied static potentials. Four gaseous products, H₂, CO, CH₄, and C₂H₄, and three liquid products, HCOOH, C₂H₅OH, and C₃H₇OH (1-propanol), were detected. No CO₂ was detected in GC throughout all the experiments while quantifying the gaseous products. The product distribution is consistent with various existing reports in the literature. As the applied potential increases, the C₂H₄ selectivity increases but at potentials higher than −1.2 V vs. RHE, HER and CH₄ formation becomes more dominant due to the activation of a high overpotential pathway for CH₄ production, which promotes the complete reduction of CO₂ over enhanced C—C coupling. Both the high and low overpotential pathways go through lower-electron products such as CO and HCOOH as the intermediates. This is why the FE of such lower electron products is not significantly affected in the range of applied potentials set forth in the exemplary embodiments herein. However, at larger overpotentials, HER becomes more dominant, leading to the reduction in the FE of CO2RR, and consequently, the reduction of the FE of lower electron products as seen from the product distribution at −1.4 V vs. RHE. The highest FE of 33% for C2H4 is seen at −1.2 V vs. RHE. Product purity is an important metric to consider in scaling up a CO2RR system as higher purity of a desired CO2RR product can be of significant economic advantage by preventing high separation costs post-CO2RR. The purity of a gaseous product is defined as the molar selectivity of a gaseous product of CO2RR. Obtaining pure products is a challenge, especially with Cu-based CO2RR systems, as they can form multiple products. The results herein focus on the purity of C₂H₄ produced from the electrochemical cell. Since the gaseous outlet contains only the CO2RR products, the product purity is calculated as:

$${P}_{j} ( \% ) = \frac{{flux}_{j}}{total flux} \times 100$$

where Pⱼ is the purity of gaseous product j, fluxⱼ is the flux of gaseous product j, and total flux is the sum of the fluxes of all the gaseous products. FIG. 10B shows the purity of the products in the gas stream. Since the flux is calculated as:

$${flux}_{j} = \frac{{i}_{j}}{{n}_{j} F} mmol / s$$

where iⱼ is the partial current of the gaseous product j, nⱼ is the number of electrons transferred to form the gaseous product j, and F=96485 C/mol is Faraday's constant. Low electron products like H₂ and CO have an advantage over higher electron products such as CH₄ and C₂H₄. H₂ is the dominant product with a product purity of >65% over the range of applied potentials as it is only a 2-electron product, whereas C₂H₄ is a 12-electron product that indicates that it requires six times more energy per electron to equal the flux of H₂ production. A maximum product purity of 10% is obtained at the applied static potential of −1.2 V vs. RHE. To further enhance the purity of C₂H₄, CO2RR was performed using a square wave oscillating potential to suppress HER and boost C₂₊ product formation. These oscillations incorporated the application of reduction potential (V_{bottom} or V_{b}) as the bottom of the square wave and an oxidation potential (Vₜₒₚ or Vₜ) as the top of the square wave. The switching time between the oxidation and reduction potentials was kept the same. Since this applied potential is where C₂H₄ has the highest FE and purity, it was chosen as the bottom potential to implement the oscillations.

### Oscillating Potential

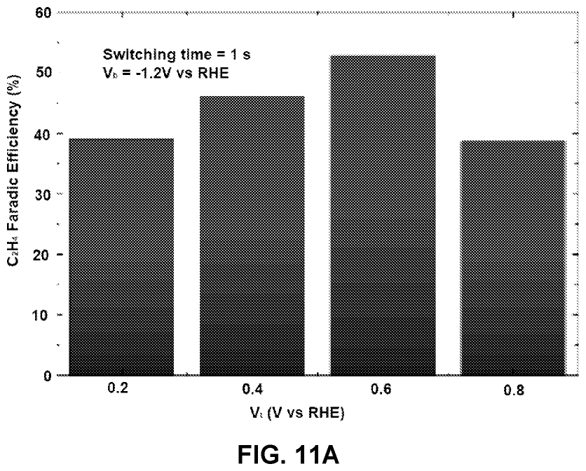

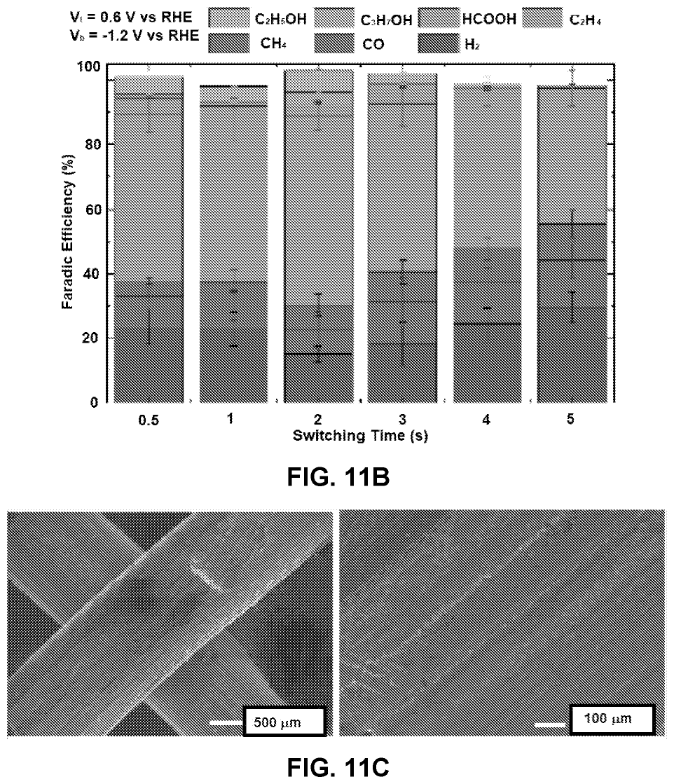

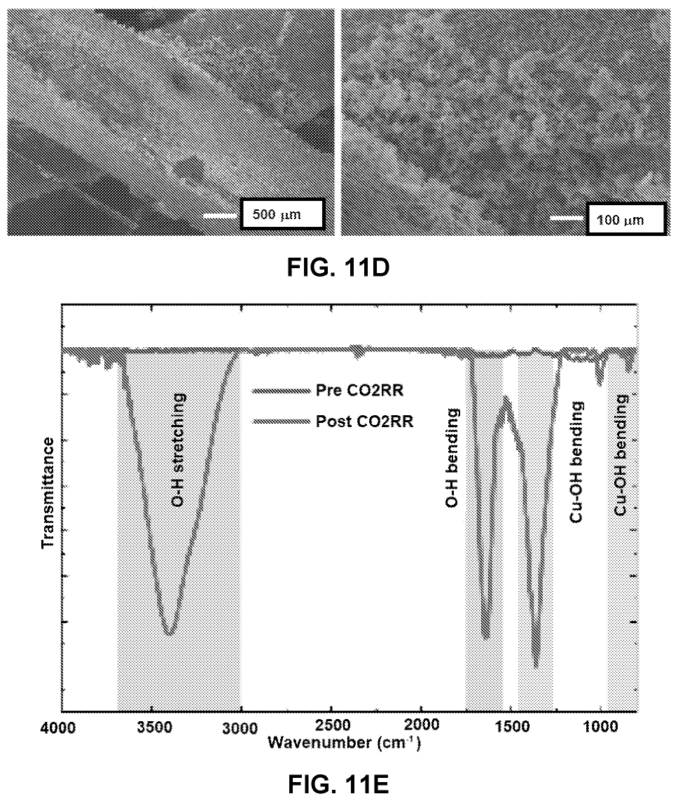

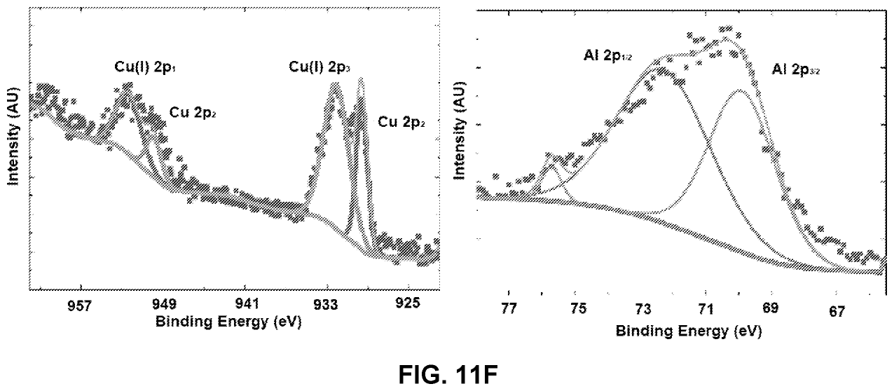

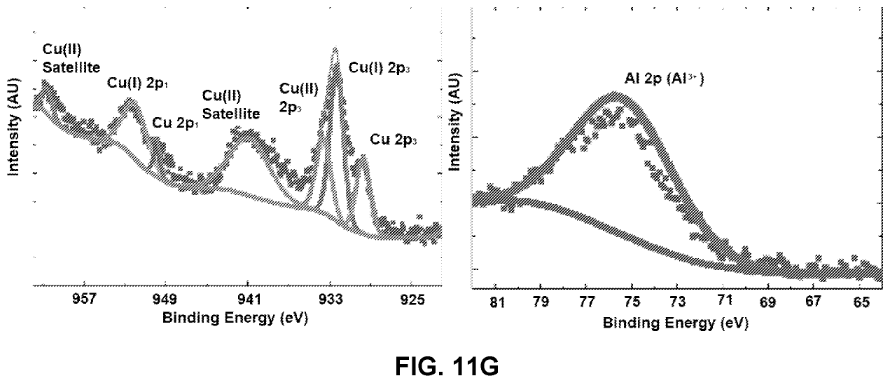

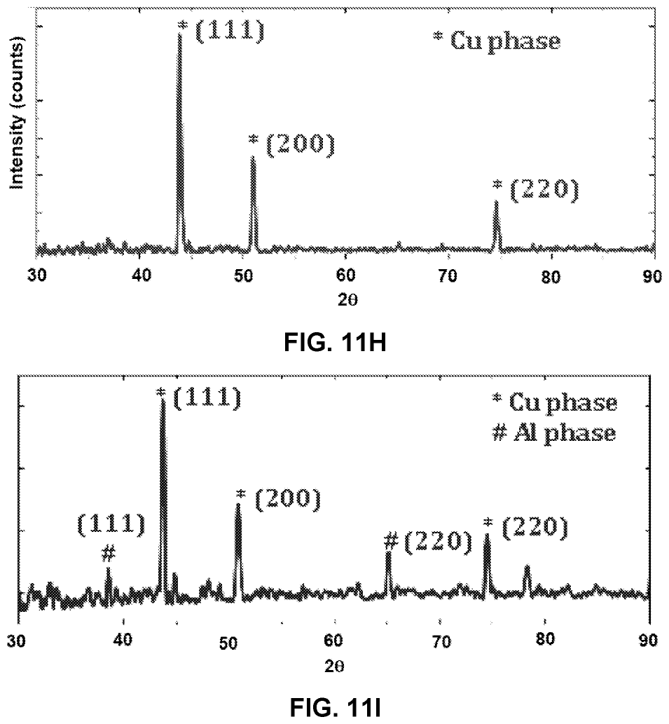

FIG. 11A shows the effect of varying Vₜ of the oscillating potential on the FE of C₂H₄ at a switching time of 1 s. Vₜ is varied from +0.2 to +0.8 V vs. RHE, and it can be seen that even at lower Vₜ, the selectivity towards C₂H₄ is higher than the maximum selectivity seen in the static potential experiments. The selectivity towards C₂H₄ increases until Vₜ reaches 0.6V; a sharp drop in C₂H₄ is observed at 0.8 V. Keeping 0.6 V as the top (oxidation) voltage in the square wave oscillation experiments, the switching time was varied, as can be seen from FIG. 11B. The switching time in the oscillations was varied from 0.5 s to 5 s, and initially, as the switching time increased, the selectivity towards C₂H₄ increased until it reached a maximum FE of 59±5% at a switching time of 2 s. As the switching time was increased beyond that point, the FE of C₂H₄ decreased. The 3D Cu mesh was characterized using SEM, EDS, XPS, FTIR, and XRD to investigate this behavior further.

FIGS. 11C-11D show the SEM micrographs of the catalyst pre- and post-CO2RR at the optimal conditions for maximum C₂H₄ FE, respectively. It can be seen from FIG. 11C that pre-CO2RR, the mesh has a uniform and smoother texture, showing that the surface consists primarily of Cu. EDS elemental mapping shows the presence of Al as well since the Cu was coated on the Al mesh. Post-CO2RR SEM micrographs from FIG. 11D show a rough texture of the mesh, indicating the change in surface structure due to oscillations. Moreover, EDS elemental mapping suggests that oxides and the density of Al on the mapped area are also more prominent than the Pre-CO2RR mesh. A quantitative analysis of elemental composition of the pre- and post-CO2RR catalyst can be seen in Table 3. It is also seen from these micrographs that there are some sharp and flaky coatings around the weaves of the Cu mesh. The repetitive oxidation and reduction on the mesh due to oscillating potential likely exfoliated the Cu from the mesh and redeposited it as Cu(OH)₂ around the weaves. This redeposited Cu(OH)₂ may be responsible for the enhanced selectivity towards C₂H₄.

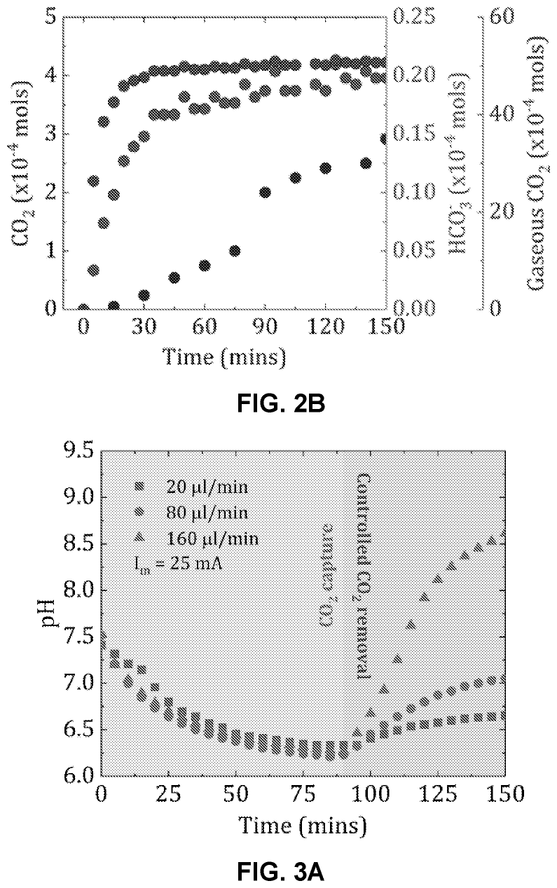

The oxidation state of the elements of Cu mesh is further confirmed by XPS in FIGS. 2.3F and 2.3G. It must be noted that the raw data acquired from XPS is scattered due to the mesh nature of the catalyst. It is challenging to extract sufficient signal-to-noise ratios from acquisition because the beam diameter is too large and focuses almost equally on the hollow and the catalyst part of the mesh, thereby increasing the noise in the spectra. Therefore, any conclusions made based on the XPS spectra are largely qualitative. Pre-CO2RR XPS spectra show Cu in its elemental form with peaks around 931 and 950 eV. The splitting of 2p peaks of the XPS also indicates a presence of the Cu(I) species which is also confirmed from the EDS quantitative analysis by the presence of 5% oxygen in the pre-CO2RR catalyst. The spectra also show an elemental Al peak around 70 and 71 eV. These intensities are found to be much lower, indicating the presence of only a small amount of Al near the surface. Post-CO2RR, the XPS spectra show mixed oxidation states of Cu in elemental, Cu(I) and Cu(II) states with the Cu(II) satellite peaks around 940 eV. Similarly, Al is also in Al(III) state, with the binding energy shifting higher at 76 eV, indicating withdrawn electrons from the elemental Al. ATR FTIR spectroscopy was performed on the pre- and post-CO2RR 2.3D Cu mesh samples to confirm the presence of Cu(OH)₂, as seen in FIG. 11E. Pre-CO2RR Cu mesh showed no vibrational modes between 800-4000 cm⁻¹, which indicates that the catalyst is IR-inactive in the scanned region. However, the post-CO2RR Cu mesh sample showed fingerprint peaks of Cu—OH vibrational modes at 1360 and 844 cm⁻¹, confirming the presence of Cu(OH)₂. XRD patterns from FIGS. 11H-11I ensure that Cu (100) facet is dominant in the pre-CO2RR sample, and then new phases of Al (111) and Al (220) emerge post-CO2RR. The characterization suggests that Cu undergoes a surface compositional change by forming Cu(OH)₂ on the oxidation cycle that de-alloys from the initial Cu—Al structure. This sharp and flaky redeposited Cu(OH)₂ around the weaves of the Cu mesh contributes to increasing the selectivity towards C₂H₄ formation. This phenomenon was also observed by De Luna et al., where the Cu catalyst increases the ratio of C₂H₄/CH₄ selectivity by changing the morphology of Cu crystals by dissolution and electro-redeposition of oxidized Cu species. Moreover, Zhong et al. showed that Cu—Al provides multiple surface orientations and active sites with an enhanced *CO binding favorable towards CO2RR. They also show that dealloying of Cu from Al enables a favorable coordination environment for Cu that enhances C—C coupling. These findings support the high selectivity of the 3D Cu mesh catalyst towards C₂H₄ formation. Optimal oxidation potential of 0.6 V is sufficient to exfoliate the surface Cu just enough to not over-expose the CO2RR inactive Al phase of the catalyst. A switching time of 2 s was optimal as longer switching times exposed the Cu mesh to more extended oxidation periods that prevented the redeposition of Cu(OH)₂ and exposed more CO2RR-inactive Al catalytic sites, leading to reduced selectivity towards C₂H₄ production.

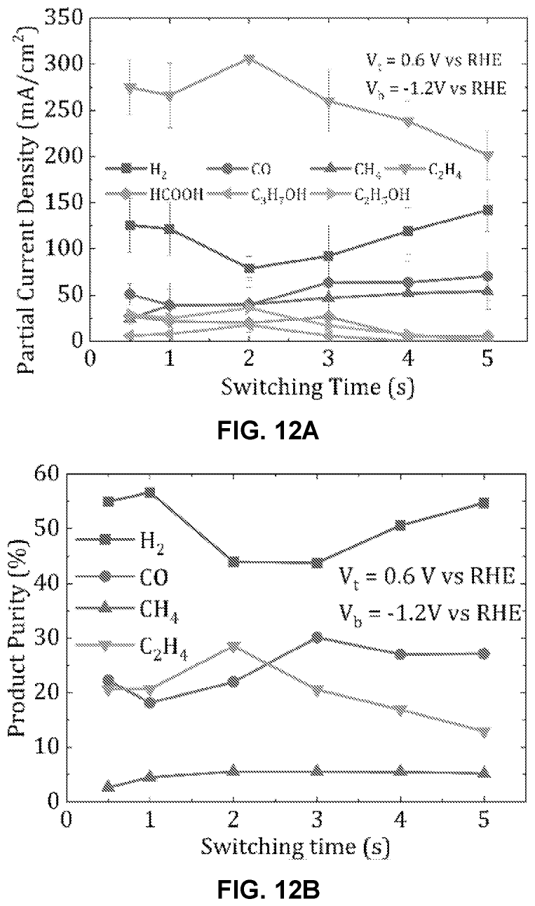

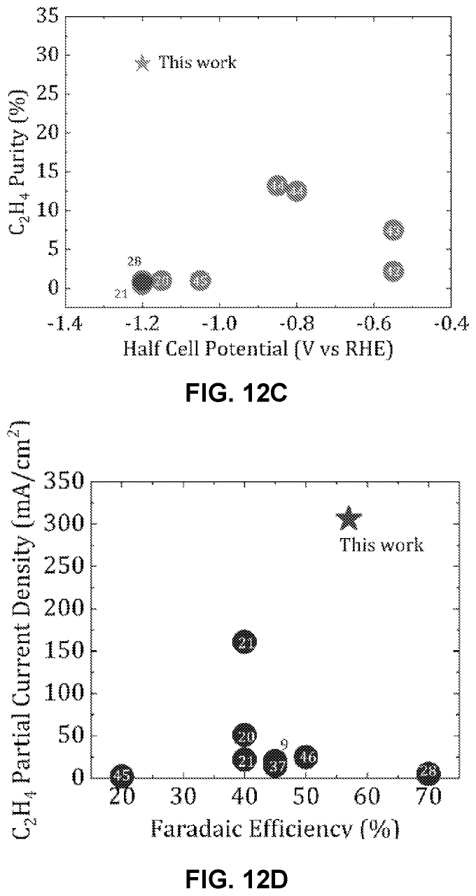

FIG. 12A shows the partial current densities of all the CO2RR products for the optimized square wave applied potential for a high C₂H₄ selectivity obtained from FIG. 11A. A high C₂H₄ current density of 306.3 mA/cm² during the reduction part of the square wave potential is obtained at a switching time of 2 s. The gaseous product purity obtained for these experiments can be seen in FIG. 12B. A stream containing 28.7% C₂H₄ at the outlet of the electrochemical cell is one of the highest reported values in the recent literature. A comparison of C₂H₄ purity in the exit stream of a CO2RR system with the half-cell applied potential is shown in FIG. 12C. The current design shows a remarkable 28.7% C₂H₄ purity compared to the systems with a similar half-cell potential of −1.2 V vs. RHE. It also offers almost double the product purity compared to the electrochemical systems with lower overpotentials. Another comparison of C₂H₄ partial current density and its FE is seen in FIG. 12D. This comparison is done specifically for non-GDE based electrochemical systems as the premise of the investigations carried out herein, and focuses on generating CO₂-free gaseous products. The FE reported herein is among the high FEs reported for C₂₊ product synthesis. Moreover, the Cu-mesh catalyst shows a higher partial current density of C₂H₄ production compared to the existing reports in the recent literature with electrochemical cells of similar architecture.

### Solar-Driven CO2RR

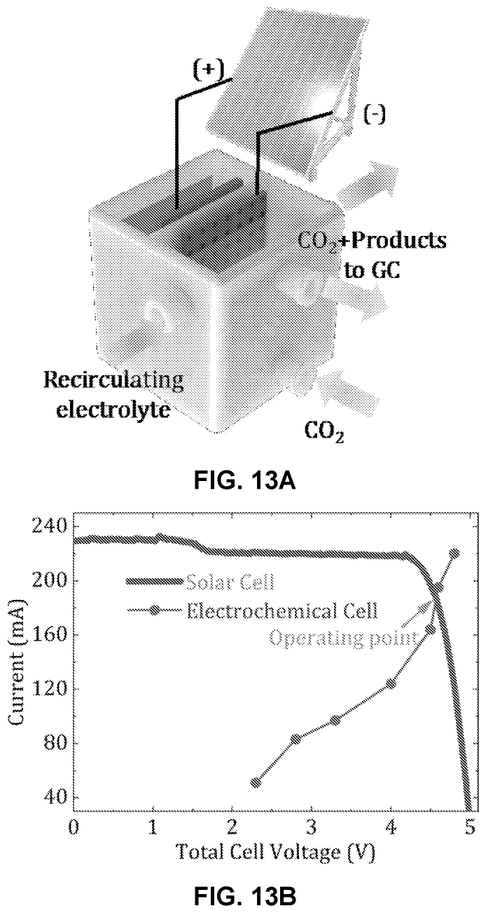

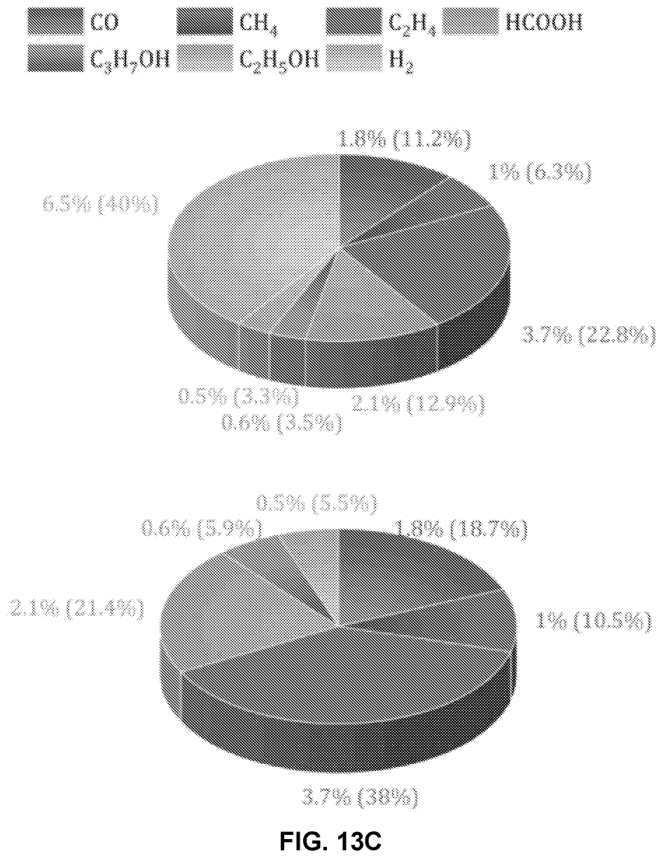

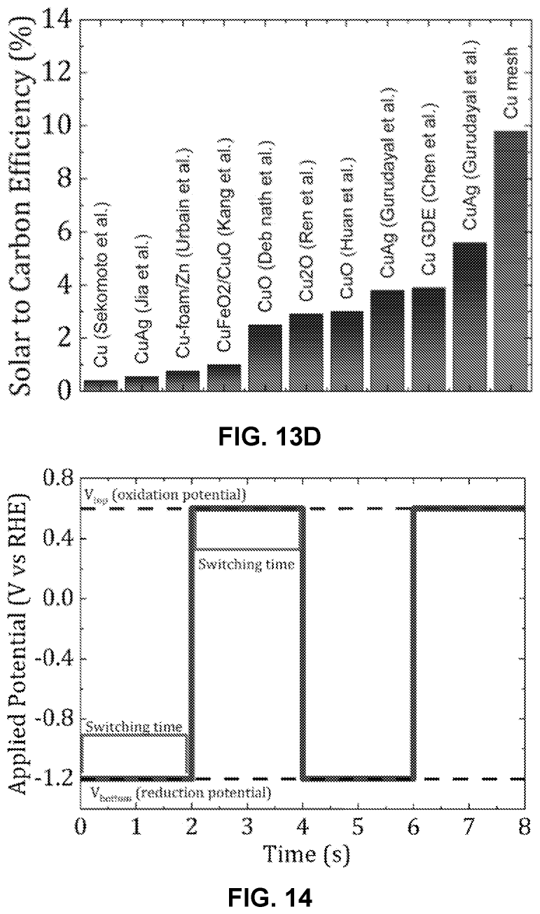

Solar-driven CO2RR was performed by using two Spectrolab's XTJ (GaInP/GaAs/Ge) triple-junction solar cells in tandem with a membrane-less electrochemical cell as seen in FIG. 13A. The measured power efficiency of a single solar cell was 46.83% with an illumination area of 16 cm² irradiated under AM 1.5G using Newport Oriel LCS-100 solar simulator.

The CO2RR experiments were performed with a 2-electrode setup with the counter electrode acting as both counter and reference electrodes and 3D Cu mesh as the working electrode. The curve in FIG. 13B shows the current-voltage (JV) curve of the light absorber setup with a short-circuit current of ˜235 mA and an open-circuit voltage of 4.97 V. The curve shows the total current of the electrochemical cell at different total cell potentials. The intersection of these two curves gives us the operating point of the solar-driven setup with a current of ˜195 mA and a total cell voltage of 4.68 V. Since the solar-driven experiments are restrictive in applying oscillating potentials, the system was relaxed to open-circuit mode and then returned to the operating point with a switching time of 2 s using an Arduino microcontroller with a relay circuit. This limitation may not let the catalyst perform at its optimum level, but there is still a considerable CO2RR observed in FIG. 13C. The total STF efficiency of 16.21% and the total STC efficiency of 9.72% with a solar-to-C₂H₄ efficiency of 3.71% were obtained from the solar-driven CO2RR. FIG. 13D shows the comparison of the STC of the solar-driven CO2RR systems in the recent literature. The 3D Cu mesh shows a remarkably high STC efficiency among the Cu-based solar-driven CO2RR systems.

In accordance with the principles herein, exemplary systems were developed and implemented in a liquid flow-through electrochemical CO2RR system using a 3D mesh electrode for enhanced mass transfer and to attain higher CO2RR currents in a liquid phase system rather than a conventional GDE system. The system was designed to collect gaseous CO2RR products free from the C02 stream. A maximum FE of 33% for C2H4 at −1.2 V vs RHE was obtained with the standard static potential experiments. Using this applied potential as the bottom potential, the effect of square wave oscillating potentials on the selectivity of CO2RR to C₂H₄ was systematically studied. The catalyst showed high selectivity towards C₂H₄ with oscillating potentials. The oscillations were optimized with the bottom voltage, Vb, fixed at −1.2 V vs. RHE, the top voltage, Vt, varied from 0.2 to 0.8 V vs. RHE, and the switching time between the oxidation and the reduction phase varied from 0.5 to 5 s. A maximum FE of 59±5% for C2H4 was obtained with V_{b}=−1.2 V, Vₜ=0.6 V vs RHE and switching time=2 s. Pre- and post-CO2RR characterization of the 3D Cu mesh revealed the trace amounts of Al on the surface and underneath the Cu. The oscillations re-deposited the surface Cu were identified as flaky, needle-like Cu(OH)₂ around the weaves of the mesh. The exfoliation of the surface Cu also revealed more Al sites. The combination of the presence of Cu(OH)₂ flakes and the coordination of Cu—Al helped enhance the selectivity of CO2RR to C₂H₄. Due to the nature of the electrochemical cell setup, a CO₂-free, high purity C₂H₄ of ˜28% was obtained at the outlet product stream. Furthermore, solar-driven CO2RR with the 3D Cu mesh showed a remarkably high STF efficiency of ˜17% and STC efficiency of ˜10%. The solar-to-C2H4 efficiency of ˜4% is almost double the state-of-the-art CO2RR systems. The excellent selectivity and activity of 3D Cu mesh for C₂H₄ production under oscillating potentials can be a stepping stone to synthesizing green plastics. The accessibility of the CO₂-free gaseous product saves the additional gas separation step to remove the CO₂ in the product stream, further enhancing the economic viability of this electrochemical system.

### Example 3: Experimental Information for CO₂-Free, High-Purity Ethylene from Electroreduction of CO₂ on a 3D Cu Mesh with 4% Solar-to-Ethylene Efficiency

### Electrochemical Measurements

The electrochemical cell was designed in SOLIDWORKS and printed using a PMMA clear resin in a FormLabs Form 2 3D printer. The printed parts were then washed with isopropyl alcohol for 30 mins and UV cured for 3 hours. All the experiments were performed in this 3D printed cell. The resin used is resistant to harsh chemical environments. A 25:75 V/V ratio of 0.1 M KHCO₃ and 1 M KCl was used as the electrolyte for all the experiments. The cell consists of a working and a counter compartment separated by SnowPure Excellion 1200 anion exchange membrane (AEM) of 0.33-0.35 mm dry membrane thickness. The AEM is a quarternary ammonium-based membrane and a polymeric backbone supplied in Cl− form that is ideal for the electrolyte used in the CO2RR experiments herein. A Pt strip or Ni foam was used as the counter electrode in the counter compartment. In the working compartment, an Ag/AgCl micro-reference electrode was inserted. The overall applied potential to the working electrode was determined by:

$${V}_{actual} = {V}_{applied} + 0.205 + 0.059 \times pH$$

The electrochemical experiments were done using a Biologic SP300 potentiostat. The square wave oscillations were implemented by using a loop-mode of the potentiostat wherein two separate chronoamperometry techniques were set up and the potentiostat looped over the techniques for a desired amount of time. Initially, a chronoamperometry for a reduction potential V_{b} was conducted for time t. Immediately after its completion, another chronoamperometry for an oxidation potential Vₜ was performed for the same time t. This seamless integration of the two chronoamperometric techniques simulated square wave potential oscillations for various Vₜ and t. A schematic of a sample square wave potential can be seen in FIG. 14. The solid line represents the oscillating potential, the dashed line on the top is the Vₜₒₚ (oxidation potential) and the bottom dashed line is the V_{bottom} (reduction potential). The shaded zones indicate the switching times. For a square wave, both the bottom and the top switching times are of equal duration. Voltages in various embodiments can include a range from 0.8 V to −1.2 V, or any other suitable voltage for a particular fluid flow.

In the electrochemical cell, the top headspace of the working compartment was where Ar was swept to collect the gaseous products and transport them to the gas chromatograph (GC) for quantification. The liquid products were quantified by high-pressure liquid chromatography (HPLC).

### Gas Chromatography

Gaseous products were quantified using an SRI 8610C GC MG #5. At the interval of 15 minutes, the gaseous products evolved were detected by passing the outlet from the electrochemical cell to the GC with argon as the carrier gas, and the product detection was done through thermal conductivity detector (TCD) and flame ionization detector (FID). The product gases in the GC were passed through two size-exclusion columns, Mol-sieve 8A and HaySep D. HaySep D efficiently separates larger molecules like C2H4. Smaller molecules like H₂ (from HER), CO, and CH₄ were separated through Mol-sieve 8A. The hydrocarbons were detected using FID and non-hydrocarbon products were detected using TCD. GC operates continuously with the electrochemical experiments. Hence, the concentration of the products obtained during an oscillating potential experiment represents the average concentration of the products evolved as no products are formed during the experiments' oxidation cycle. The actual flux of the products is calculated by accounting for the time spent exclusively on the reduction cycle.

### High-Pressure Liquid Chromatography

The quantification of liquid products of CO₂ reduction was performed using High-pressure liquid chromatography (HPLC) on Agilent Infinity 1260 II HPLC with a 300 mm×7.5 mm Agilent Hi-plex-H column and a refractive index detector (RID). An isocratic elution of 1 mM H₂SO₄ mobile phase was established at 0.6 mL/min. The column temperature was set to 60° C., and the RID temperature was set to 35° C. For each sample analysis with a total run time of 30 min, a 10 μL sample was injected into the system through an autosampler. This operating method was developed by observing the retention times of the electrolyte and the possible CO₂ reduction products: HCOOH, HCHO, CH₃OH, CH₃COCH₃, CH₃COOH, C₂H₅OH, and C₂H₂O₄ so that none of the peaks overlap with each other in the shortest run time. The flux of the liquid products is calculated similarly to the flux of gaseous products by accounting for the time spent only on the reduction cycle of the oscillating potential experiment.

### Characterization

Scanning Electron Microscopy (SEM) and Energy Dispersive X-Ray Spectroscopy (EDS): SEM and EDS for pre and post-CO2RR 3D mesh catalyst was done using Hitachi SU8030 Field Emission SEM. The image scans were done at an accelerating voltage of 5 kV and 10 ρA of emission current at varying magnifications. The EDS elemental mapping and identification was done at an accelerating voltage of 20 kV and enabling the signals from both upper and lower detectors to get the maximum signal collection.

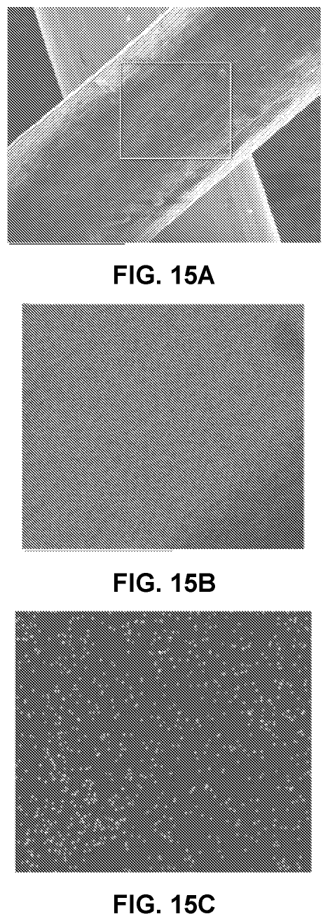

FIGS. 15A-15C shows the SEM image and the EDS elemental mapping for the pre-CO2RR 3D mesh catalyst. The square on the micrograph in FIG. 15A is the area selected for EDS elemental mapping. EDS revealed that the 3D Cu mesh catalyst has trace amounts of Al.

FIGS. 15B-15C show the elemental maps of Cu and Al which are confirmed to be in there elemental (zero) state as seen from the XPS data collected.

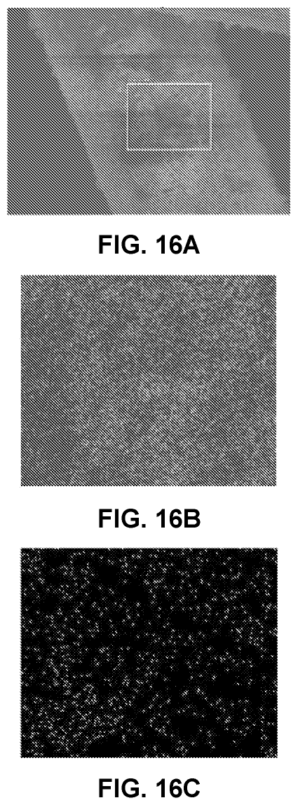

FIGS. 16A-16D shows the SEM image and EDS elemental mapping of the post-CO2RR 3D mesh catalyst. FIG. 16A shows a rough texture and sharper gradients on the surface of the mesh indicating that the catalyst has undergone some structural changes. The square on the micrograph in FIG. 16A is the area selected for EDS elemental mapping. The elemental mapping revealed a reduced presence of Cu compared to the pre-CO2RR 3D mesh an increased presence of Al as seen in FIGS. 16B-16C. Furthermore, FIG. 16D shows the presence of O as well. This could be attributed to the formation of both Cu(OH)₂ and Al(II) oxide as confirmed by FTIR and XPS data collected.

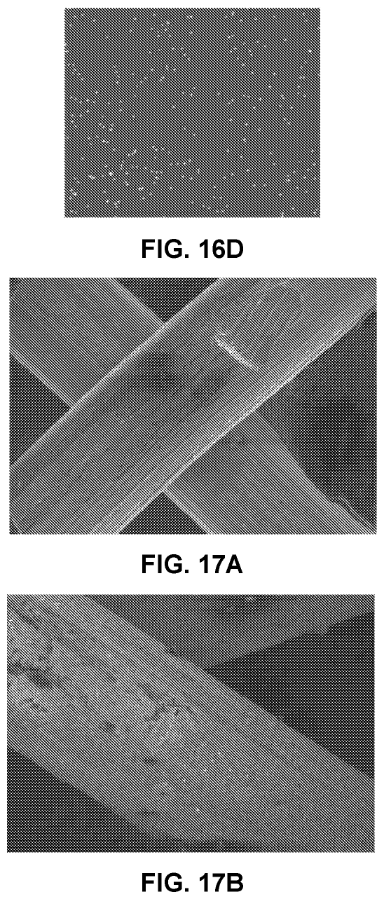

FIGS. 17A-17B shows the SEM micrographs of pre- and post-CO2RR 3D mesh catalyst for a switching time >2 s. Both the images are taken at a similar magnification. FIG. 17A shows the smooth texture of the pre-CO2RR catalyst as seen in the SEM micrographs in FIG. 2.3. FIG. 17C shares some similar features with the post-CO2RR catalyst but it can be seen that the even though the surface has a rough texture, the sharp, flaky Cu(OH)₂ deposits around the weaves of the mesh are absent. The longer switching time implies that the oxidation phase will also be longer in the square wave oscillating potential experiments. This enhances the surface exfoliation but prevents formation and re-deposition of Cu(OH)₂ and therefore, a reduction in the CO2RR activity and selectivity towards C₂H₄ can be seen. Further quantification by EDS can be seen in Table 3. Here, the atomic % of carbon detected during the acquisition of the EDS spectra was considered as an impurity and hence, ignored from the total atomic % calculation of the catalyst. The data seen in Table 3 is normalized after excluding the influence of the impurities. Before CO2RR, the catalyst consists only of Cu and Al with a Cu:Al ratio of 4.42:1. If the Cu and Al both were uniformly distributed on the catalyst surface then the ratio of the Cu:Al would likely remain constant as both may undergo structural changes under the oscillating potential. However, after CO2RR, the Cu:Al ratio changes to 2.39:1 indicating that the Cu and Al are not uniformly distributed on the surface of the catalyst. The catalyst undergoes exfoliation due to repeated oscillating potentials.

TABLE 3
Elemental Composition of the Pre- and Post-
COTRR Catalyst in Terms of Atomic %

| Element | Pre-CO2RR (atomic %) | Post-CO2RR (atomic %) |
|---|---|---|
| Cu | 76.79% | 62.19% |
| Al | 17.36% | 25.96% |
| O | 5.12% | 11.84% |

### X-Ray Photoelectron Spectroscopy (XPS)

XPS for pre electrocatalysts before and after CO2RR was done using Thermo Scientific ESCALAB 250XI microprobe with an Al Kα source. The beam diameter was set to an optimal value of 500μμμμ. Each analysis consisted of a survey scan to check for impurities and an elemental scan to access the chemical state of the catalyst. All the XPS spectra were corrected for charge shift using C 1 s at 284.8 eV as the reference. For maximum signal to noise ratio, at least 10 spectra were acquired for the survey scan and 20 were acquired for the individual elemental scans for Cu and Al.

### X-Ray Diffraction (XRD)

The crystal structure of the Cu mesh was analyzed using Bruker D8 Discover X-Ray Diffractometer using Cu-Kα radiation (40 kV, 40 mA, and A=1.5418 Å). The diffractometer was equipped with parallel beam optics and a 0.5° parallel slit analyzer. Göbel mirror was used on the primary side and LYNXEYE detector with 196 channels (channel width 14.4 mm) was used on the detection side. Ni filters were used to remove Kβ coming from Cu radiation. The detector slit was set to 1.2 mm. Two-theta scan was performed with a primary rotary absorbance value of 73.88 to get the offset of the beam with sample holder in place and external offset correction was made. Z scan was performed with auto primary rotary absorbance to locate the sample edge, followed by Rocking scan with a primary rotary absorbance value of 73.88 to find the angular offset of the sample and flatness correction was made. Coupled two theta/theta scans were performed with auto primary rotary absorbance from 30° to 90° with a step size of 0.02°. The data was processed using Diffrac Suite Eva software and background subtraction was performed. The data is matched with the crystallography open database and the peaks are identified.

### Fourier Transform Infrared (FTIR) Spectroscopy

FTIR analysis (Invenio S, Bruker) was performed to confirm the structural changes between the pre- and the post-CO2RR 3D mesh catalysts. The analysis was done in the attenuated total reflectance (ATR) mode using Pike VeeMax Ill variable angle accessory with a germanium 60° face-angled crystal. The spectra for the catalysts were collected at a resolution of 4 cm⁻¹ with 64 scans per sample with a low sampling rate of 7.5 kHz. The beam aperture was adjusted to 6 mm and the specular angle was kept at 64.5° to attain maximum signal from the spectra and was compensated for the presence of atmospheric CO₂ and moisture.

The pre-CO2RR 3D mesh catalyst was taken as is for spectra acquisition. The post-CO2RR 3D mesh catalyst was taken out of the electrochemical cell after the experiment and Ar dried to remove the aqueous electrolyte and then mounted on to the FTIR spectrometer for spectra acquisition. For both the samples, an IR inactive Al foil was taken as the background signal. Calculations of STF and STC efficiencies Solar-Driven CO2RR experiments were done using a custom 3D printed membrane-less cell and a Newport Oriel LCS-100 solar simulator with an area of illumination of 16 cm². The general expression to calculate any STF efficiency is given by:

$${η}_{STF} = \frac{{P}_{out}}{{P}_{in}} \times 100 = \frac{{P}_{EC}}{{P}_{solar}} \times 100$$

where η_{STF} is the STF efficiency, Pᵢₙ or Pₛₒₗₐᵣ is the input power which is the power irradiated by the sun on the earth's surface at AM 1.5 G, and Pₒᵤₜ or P_{EC} is the output power or the total power required by the electrochemical cell to produce fuels. Since the nominal power density from the sunlight reaching the earth's surface is 100 mW/cm², the total solar power for an area of illumination of 16 cm² can be given as:

$${P}_{solar} = 100 \frac{mW}{{cm}^{2}} \times 16 {cm}^{2} = 1600 mW$$

The power required by an electrochemical cell for a single product is:

$${P}_{EC , j} = {i}_{j} \times {E}_{0 , j}$$

where P_{EC,j} (mW) is the power required by the electrochemical cell to produce a fuel j, iⱼ (mA) is the partial current of the product j, and E_{0,j} (V) is the equilibrium potential of the cell.

TABLE 4
Equilibrium Cell Potential for All Observed CO2RR and HER Reactions

| | | Equilibrium | Equilibrium |
|---|---|---|---|
| | No. of | Reduction | Cell Potential |
| Overall Reaction | Electrons | Potential (V) | (V) |
| H2O → H2 + ½ O2 | 2 | 0 | 1.229 |
| CO2 → CO + ½ O2 | 2 | −0.1 | 1.329 |
| CO2 + 2H2O → CH4 + 2 O2 | 8 | 0.17 | 1.059 |
| 2CO2 + 2H2O → C2H4 + 3O2 | 12 | 0.08 | 1.149 |
| CO2 + H2O → HCOOH + ½ O2 | 2 | −0.12 | 1.349 |
| 2CO2 + 3H2O → C2H5OH + 3 O2 | 12 | 0.09 | 1.139 |
| 3CO2 + 4H2O → C3H7OH + 9/2 O2 | 18 | 0.1 | 1.129 |

Using the equilibrium cell potential values from Table 4 and the definition of STF from equation (2), the STF efficiency for each product is calculated as:

$${η}_{STF , j} = \frac{{P}_{EC , j}}{{P}_{solar}} \times 100 = \frac{{i}_{j} \times {E}_{o , j}}{1600} \times 100$$

where η_{STF,j} is the STF efficiency of a product j. Consequently, the total STF efficiency can be calculated as:

$${η}_{STF , j} = {\sum }_{j} \frac{{P}_{EC , j}}{{P}_{solar}} \times 100 = {\sum }_{j} \frac{{i}_{j} \times {E}_{o , j}}{1600} \times 100$$

The total Solar-to-carbon (STC) efficiency is the efficiency of power consumed to produce only CO2RR products and is a metric calculated similarly as the total STF efficiency as described above using only the CO2RR products and excluding the STF efficiency of HER.

### State-of-the-Art STC Systems in the Literature

Table 5 presents state-of-the-art Cu-based STC systems in the known literature:

TABLE 5
List of STC Systems with Cu-Based Electrocatalysts
for CO2RR from Recent Literature

| | | Major | Total |
|---|---|---|---|
| Sr No. | Catalyst | Product | STC (%) |
| 1 | Cu | C₂H₄ | 0.41 |
| 2 | CuAg | CH₄ | 0.56 |
| 3 | Cu-foam/Zn | CO | 0.77 |
| 4 | CuFeO2/CuO | HCOOH | 1 |
| 5 | CuO | CO | 2.5 |
| 6 | Cu2O | C₂H₄ | 2.9 |
| 7 | CuO | C₂H₄ | 3 |
| 8 | CuAg | C₂H₄ | 3.8 |
| 9 | Cu GDE | C₂H₄ | 3.9 |
| 10 | CuAg | C₂H₄ | 5.6 |
| 11 | 3D Cu mesh | C₂H₄ | 9.79 |
| | (present disclosure) | | |

Table 6 presents the calculated product purity of C₂H₄ from CO2RR in the recent literature:

TABLE 6
Recent Reports on C₂H₄ Purity at the
Outlet of CO2RR Electrochemical Cells

| | Applied potential | |
|---|---|---|
| Sr No. | (V vs RHE) | C₂H₄ Purity (%) |
| 1 | −1.05 | ~1 |
| 2 | −0.55 | 2.2 |
| 3 | −0.8 | 12.5 |
| 4 | −0.85 | 13.2 |
| 5 | −0.55 | 7.5 |
| 6 | −1.2 | ~1 |
| 7 | −1.15 | ~1 |
| 8 | −1.2 (present | 28.52 |
| | disclosure) | |

### Choice of Electrolyte

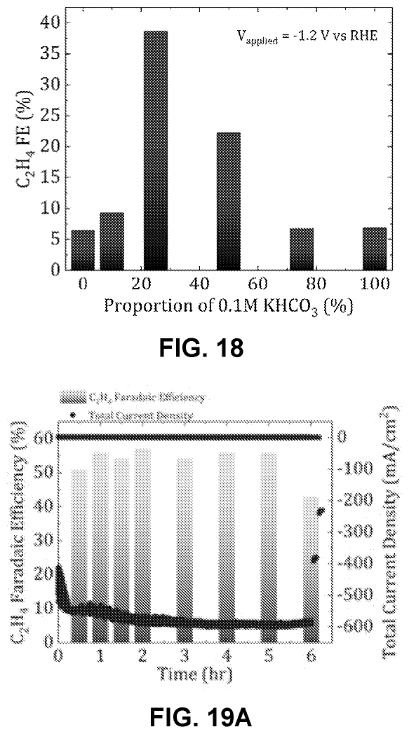

The electrolyte used in this work is 25% 0.1M KHCO₃ and 75% 1M KCl (v/v). After varying the electrolytes' concentration in the CO2RR system and evaluating the product distribution for each different ratio, this ratio was used. Since the electrolyte selection was made prior to implementing the oscillating potentials, the performance of the CO2RR systems while screening for an appropriate electrolyte ratio was conducted at static potential experiment. FIG. 18 shows the effect of different 0.1M KHCO₃ ratios on the FE of C₂H₄ at −1.2V vs. RHE. It can be seen that only 25% and 50% solutions show a high C2H4 FE >20%, and the electrolyte with 25% KHCO₃ shows the highest FE at 38.7%. Hence, a mixture of 25% 0.1M KHCO₃ and a 75% 1M KCl was chosen as the electrolyte for this work.

### Stability of the CO2RR System

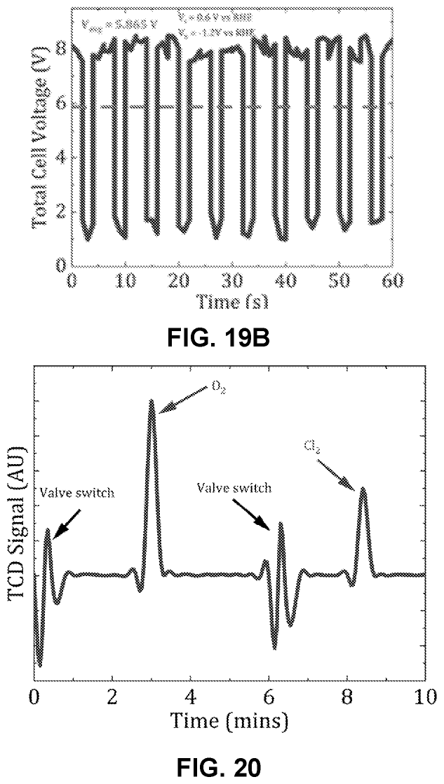

A long-term stability test was performed on the system to determine the stability of the 3D mesh catalyst and the electrolyte for a high-rate C₂H₄ synthesis. The C₂H₄ FE was monitored over time for a 6-hour long experiment. During the initial hours of operation, the C₂H₄ FE was monitored every 30 mins and then later at every 1 hour. It can be seen from FIG. 19A that this system is consistently selective to produce C₂H₄ for ˜6 hours. The FE is in the range of 54-58%, which agrees with the short-term 1-hour experiments reported in the manuscript. The reduction current is in the order of ˜580 mA/cm², and the oxidation current stays at a low value of ˜2 mA/cm² throughout the experiment. A snippet of the total cell voltage is shown in FIG. 19B. During the reduction cycle, the total cell voltage was between 7-8V, but in the oxidation cycle, it dropped to 1-2V. The average total cell voltage was 5.865V for 1 hour of operation.

After 6 hours of operation, the FE drops to ˜43%, indicating degradation of the electrochemical system. This degradation was further investigated by analyzing the product distribution at the anode.

### Qualitative Gaseous Product Distribution at the Anode

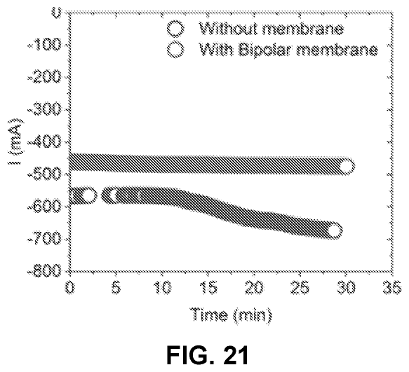

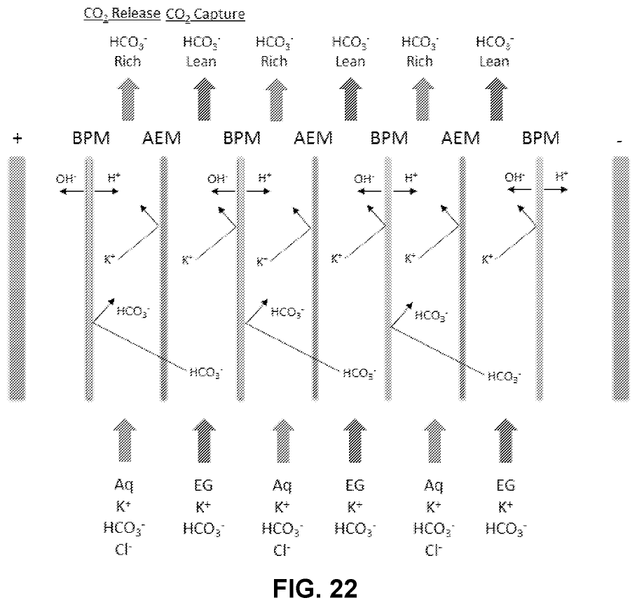

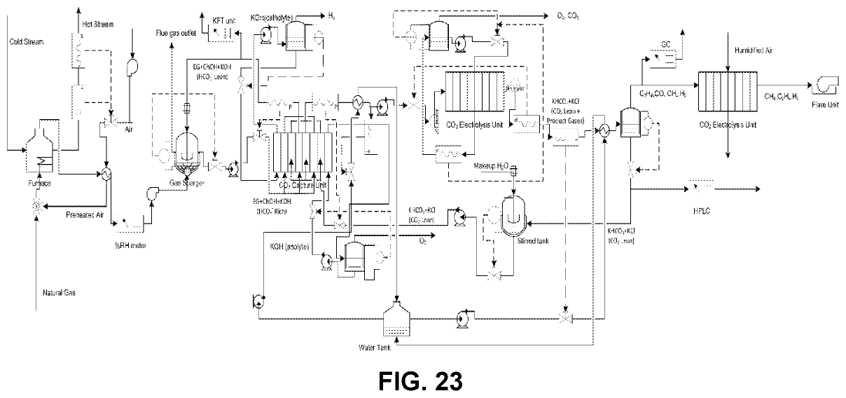

Gaseous products for the optimum oscillating square wave potential experiments were performed by modifying the experimental setup such that the product gases from the anode were swept using Ar from the anodic compartment to the GC. The anodic products were detected using the thermal conductivity detector of the GC. FIG. 20 shows the chromatogram for the anodic products. Oxygen is the dominant product at the anode, with a small amount of Cl₂ gas evolution also detected as a result of Cl⁻ oxidation from the electrolyte. This indicates that the consumption of Cl⁻ from the system affects the performance of the catalyst, and the C₂H₄ selectivity drops after 6 hours of continuous operation, as seen in FIG. 19A. To prevent Cl⁻ migration and its oxidation at the anode, a bipolar membrane can be implemented. FIG. 21 shows current (for 1 cm² geometric electrode area) with and without bipolar membrane. As compared to the membrane less cell, there is a reduction in current due to ohmic losses in the bipolar membrane. However, the chlorine evolution is suppressed significantly and the amount of chlorine gas at the anode is at sub ppm level.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A system comprising: a composition of a catalyst and electrolytes for substantially continuous CO₂ capture and reduction to one or more value-added products, and wherein the rate of CO₂ captured is substantially equal to the rate of CO₂ reduction.

2.-3. (canceled)

4. The system of claim 1, the catalyst comprising of supported or unsupported mesh electrodes comprising Cu, at least one copper oxide, a Cu—Al alloy, or any combination thereof.

5.-6. (canceled)

7. The system of claim 4, wherein the supported mesh electrodes comprise an Al support.

8. (canceled)

9. The system of claim 4, further comprising a membrane separating an anodic side from a cathodic side in the system, wherein the mesh electrodes are present on the cathodic side in the system.

10. (canceled)

11. The system of claim 9, wherein the membrane prevents one or more solutes from crossing from the anodic side to the cathodic side, from the cathodic side to the anodic side, or both.

12. (canceled)

13. The system of claim 9, wherein the membrane reduces or eliminates Cl₂ production relative to an otherwise identical membrane-less system.

14. (canceled)

15. The system of claim 1, wherein the system has a current density of from about 550 mA/cm² to about 600 mA/cm².

16. The system of claim 1, wherein the system has a partial current density of ethylene of from about 250 mA/cm² to about 300 mA/cm².

17. The system of claim 1, wherein the catalyst comprises active sites for CO₂ reduction comprising at least one of a strained Cu layer with 111, 200, or 220 facets.

18. (canceled)

19. The system of claim 1, wherein the electrolytes comprise CO₂ dissolved in a solution of alkali chloride and alkali bicarbonate in water.

20. The system of claim 19, wherein the electrolyte composition comprises from about 0.5 M to about 1 M of alkali chloride and from about 0.01 M to about 0.03 M of alkali bicarbonate.

21. (canceled)

22. The system of claim 19, wherein the alkali chloride comprises KCl, NaCl, or any combination thereof, and wherein the alkali bicarbonate comprises KHCO₃, NaHCO₃, or any combination thereof.

23. (canceled)

24. The system of claim 1, further comprising an integrated CO₂ capture and conversion device.

25.-27. (canceled)

28. A method for maximizing efficiency of solar conversion of CO₂ to one or more value-added products, the method comprising manufacturing a system according to claim 1 and operating the system using a solar-powered electrochemical reactor and a dilute CO₂ feedstock.

29. The method of claim 28, wherein the dilute CO₂ feedstock comprises flue gas or air.

30. The method of claim 28, wherein the one or more value added products comprise CO, CH₄, C₂H₄, C₂H₅OH, CH₃COOH, CH₃OH, C₃H₆, H₂, or any combination thereof.

31. The method of claim 30, wherein the one or more value-added products comprise C₂H₄ and wherein a selectivity ratio of C₂H₄ to CH₄ is at least about 200:1.

32.-34. (canceled)

35. The method of claim 34, wherein the one or more value-added products are produced at a current density of up to about 300 mA/cm² in a liquid-fed electrochemical reactor.

36. The method of claim 28, wherein the one or more value-added products are produced at a current density of up to about 1000 mA/cm² in a gas-fed electrochemical reactor.

37. (canceled)

38. The method of claim 28, wherein the continuous CO₂ capture and reduction system operates at less than 120 kJ/mol of energy using an electrodialysis unit.
